(19) United States
(12) Patent Application Publication
(10) Pub. No.: US 2024/0118644 A1
(43) Pub. Date: Apr. 11, 2024

(54) SILICA PARTICLES, ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Mieko SEKI, Kanagawa (JP); Sakae TAKEUCHI, Kanagawa (JP); Yuka ZENITANI, Kanagawa (JP); Hajime SUGAHARA, Kanagawa (JP); Mai MOCHIDA, Kanagawa (JP); Kota NOHARA, Kanagawa (JP)

(73) Assignee: FUJIFILM Business Innovation Corp., Tokyo (JP)

(21) Appl. No.: 18/313,353

(22) Filed: May 7, 2023

(30) Foreign Application Priority Data
Sep. 21, 2022 (JP) 2022-150742

(51) Int. Cl. G03G 9/097; G03G 9/08

(52) U.S. Cl. CPC G03G 9/09725; G03G 9/0819; G03G 9/0821; G03G 9/09716

(57) ABSTRACT

Silica particles having silica base particles, a coating structure that coats the silica base particles and is composed of a reaction product of a trifunctional silane compound, and a nitrogen element-containing compound that has adhered to the coating structure and contains a molybdenum element, in which in a molybdenum element map created by SEM-EDX, a ratio of a total area of a region forming a lump having a long diameter of 500 nm or more is 5% or less to a total area of the molybdenum element.

### CROSS-REFERENCE TO RELATED APPLICATIONS

This application is based on and claims priority under 35 USC 119 from Japanese Patent Application No. 2022-150742 filed Sep. 21, 2022.

### BACKGROUND

### (i) Technical Field

The present disclosure relates to silica particles, an electrostatic charge image developing toner, an electrostatic charge image developer, a toner cartridge, a process cartridge, an image forming apparatus, and an image forming method.

### (ii) Related Art

JP2011-185998A discloses an electrostatic image developing toner obtained by mixing toner particles with charge control particles for external addition, in which the charge control particles for external addition are configured with transport particles that consist of hydrophobic spherical fine silica particles having an average particle size of 20 to 500 nm obtained by performing a hydrophobic treatment on a surface of hydrophilic spherical fine silica particles obtained by a sol-gel method and charge control agent that is made coat the surface of the transport particles, a content of the charge control agent is in a range of 1×10⁻³ to 1×10⁻¹ parts by mass with respect to 1 part by mass of the transport particles, and 0.001 to 0.05 parts by mass of the charge control particles for external addition are mixed with 1 part by mass of the toner particles.

JP2021-151944A discloses silica particles containing a quaternary ammonium salt, in which in a case where F_{BEFORE} represents a maximum frequency of pores having a diameter of 2 nm or less determined from a pore size distribution curve obtained by a nitrogen adsorption method performed on the silica particles before washing and F_{AFTER} represents a maximum frequency of pores having a diameter of 2 nm or less determined from a pore size distribution curve obtained by a nitrogen adsorption method performed on the silica particles after washing, F_{BEFORE}/F_{AFTER} as a ratio of F_{BEFORE} to F_{AFTER} is 0.90 or more and 1.10 or less, and in a case where F_{SINTERING} represents a maximum frequency of pores having a diameter of 2 nm or less determined from a pore size distribution curve obtained by a nitrogen gas adsorption method performed on the silica particles after the silica before washing is baked at 600° C., F_{SINTERING}/F_{BEFORE} as a ratio of F_{SINTERING} to F_{BEFORE} is 5 or more and 20 or less.

### SUMMARY

Aspects of non-limiting embodiments of the present disclosure relate to silica particles that contain a nitrogen element-containing compound containing a molybdenum element and are unlikely to undergo temporal changes in charge amount.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above object include the following aspect.

According to an aspect of the present disclosure, there are provided silica particles have silica base particles,
a coating structure that coats the silica base particles and consists of a reaction product of a trifunctional silane compound, and
a nitrogen element-containing compound that has adhered to the coating structure and contains a molybdenum element,
in which in a molybdenum element map created by SEM-EDX, a ratio of a total area of a region forming a lump having a long diameter of 500 nm or more is 5% or less to a total area of the molybdenum element.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a range of numerical values described using “to” represents a range including the numerical values listed before and after “to” as the minimum value and the maximum value respectively.

Regarding the ranges of numerical values described in stages in the present disclosure, the upper limit or lower limit of a range of numerical values may be replaced with the upper limit or lower limit of another range of numerical values described in stages. Furthermore, in the present disclosure, the upper limit or lower limit of a range of numerical values may be replaced with values described in examples.

In the present disclosure, the term “step” includes not only an independent step but a step which is not clearly distinguished from other steps as long as the goal of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more substances corresponding to each component in the composition, unless otherwise specified, the amount of each component means the total amount of two or more substances present in the composition.

In the present disclosure, each component may include two or more corresponding particles. In a case where there are two or more kinds of particles corresponding to each component in a composition, unless otherwise specified, the particle size of each component means a value for a mixture of two or more kinds of the particles present in the composition.

In the present disclosure, “(meth)acryl” is an expression including both the acryl and methacryl, and “(meth)acrylate” is an expression including both the acrylate and methacrylate.

In the present disclosure, “electrostatic charge image developing toner” is also called “toner”, “electrostatic charge image developer” is also called “developer”, and “electrostatic charge image developing carrier” is also called “carrier”.

Silica Particles

The silica particles according to the present exemplary embodiment have silica base particles, a coating structure that coats the silica base particles and consists of a reaction product of a trifunctional silane compound, and a nitrogen element-containing compound that has adhered to the coating structure and contains a molybdenum element.

In a molybdenum element map created by SEM-EDX for the silica particles according to the present exemplary embodiment, a ratio of a total area of a region forming a lump having a long diameter of 500 nm or more is 5% or less to a total area of the molybdenum element.

In the present disclosure, the silica particles according to the present exemplary embodiment are called “silica particles (S)”.

In the present disclosure, “a nitrogen element-containing compound containing a molybdenum element” will be called “a molybdenum nitrogen-containing compound”.

In the present disclosure, “a region forming a lump having a long diameter of 500 nm or more in a molybdenum element map created by SEM-EDX” is called “a molybdenum lump”, and “a ratio of a total area of a region forming a lump having a long diameter of 500 nm or more to a total area of the molybdenum element in the molybdenum element map created by SEM-EDX” is called “an abundance ratio of the molybdenum lump”.

The abundance ratio of the molybdenum lump is a characteristic measured by scanning electron microscope-energy dispersive x-ray spectroscopy (SEM-EDX). Specifically, the abundance ratio is measured by the following method.

Silica particles are spread on a carbon tape and fixed. At this time, the silica particles are dispersed such that the silica particles do not come into contact with each other or overlap with each other as much as possible, and the density of the silica particles is adjusted such that 500 or more and 2,000 or less silica particles are observed in one field of view of SEM at 180× magnification.

Carbon is vacuum-deposited on the silica particles, thereby preparing an SEM sample. The carbon deposition is performed for 70 seconds.

By using SEM (manufactured by Hitachi High-Tech Corporation, S-4800) equipped with an EDX device (manufactured by HORIBA, Ltd., EMAX ENERGY, detector: X-Max 80 mm²), the sample is imaged at 180× magnification. The acceleration voltage of SEM is 10 kV, and EDX detection is performed for 300 seconds for the molybdenum element. Three fields of view are images, and a total of 1,500 or more and 6,000 or less silica particles are observed.

EDX mapping data of the molybdenum element is analyzed by image processing/analyzing software WinRoof (MITANI CORPORATION) and binarized by setting 10% of the maximum brightness (L) and chroma (S) in color extraction to be a threshold, thereby creating a binarized molybdenum element map.

In the binarized molybdenum element map, a total area A1 of the molybdenum element and a total area A2 of a region forming a lump having a long diameter (that is, the major axis length of the contour) of 500 nm or more are calculated. The area ratio (percentage) of A2 to A1 is defined as “an abundance ratio of a molybdenum lump”.

Based on the presence of the molybdenum element and the shape and size observed in the SEM image, the molybdenum lumps in the molybdenum element map of the silica particles are assumed to be crystals and/or aggregates of the molybdenum nitrogen-containing compound. The presence of the molybdenum lumps in the molybdenum element map of the silica particles means that the crystals and/or aggregates of the molybdenum nitrogen-containing compound are mixed in the silica particles.

The silica particles (S) according to the present exemplary embodiment are unlikely to undergo temporal changes in charge amount. Presumably, the mechanism is as follows.

In the related art, there are silica particles having a molybdenum nitrogen-containing compound that is a compound acting as a charge control agent having adhered to the surface of the silica particles. Generally, a method of attaching a molybdenum nitrogen-containing compound to the surface of silica particles includes dissolving the molybdenum nitrogen-containing compound in a silica particle suspension and drying the silica particle suspension.

The molybdenum nitrogen-containing compound has low solubility in a medium (usually, a mixed solution of water and alcohol) of the silica particle suspension. Therefore, sometimes the crystals and/or aggregates resulting from the precipitation of the molybdenum nitrogen-containing compound are mixed into the dried silica particles.

Compared to the silica particles, the crystals and/or aggregates of the molybdenum nitrogen-containing compound are more hygroscopic. Accordingly, in a case where the silica particles into which the crystals and/or aggregates of the molybdenum nitrogen-containing compound are mixed are left at a high humidity, the charge amount changes.

On the other hand, in the silica particles (S), the abundance ratio of the molybdenum lump is 5% or less. In other words, the crystals and/or aggregates of the molybdenum nitrogen-containing compound are unlikely to be mixed or are not mixed into the silica particles. Therefore, even being left at a high humidity, the silica particles (S) are unlikely to undergo temporal changes in charge amount.

For example, the lower the abundance ratio of the molybdenum lump in the silica particles (S), the more preferable. Specifically, the abundance ratio of the molybdenum lump is, for example, preferably 3% or less, more preferably 1% or less, and ideally 0%.

The abundance ratio of the molybdenum lump in the silica particles (S) of 5% or less can be achieved by the manufacturing method of silica particles that will be described later, particularly, by an attaching step.

Because the silica particles (S) are unlikely to undergo temporal changes in charge amount, the particles (S) are unlikely to undergo temporal changes of characteristics such as fluidity. The silica particles (S) can be used, for example, as an additive component or a major component of developers, powder paint, cosmetics, rubber, abrasives, and the like.

Hereinafter, the components, structure, and manufacturing method of the silica particles (S) will be specifically described.

Silica Base Particles

The silica base particles may be dry silica or wet silica.

Examples of the dry silica include silica by a combustion method (fumed silica) obtained by combustion of a silane compound and silica by a deflagration method obtained by explosive combustion of metallic silicon powder.

Examples of the wet silica include wet silica obtained by a neutralization reaction between sodium silicate and a mineral acid (silica by a precipitation method synthesized/aggregated under alkaline conditions, silica by a gelation method synthesized/aggregated under acidic conditions), colloidal silica obtained by alkalifying and polymerizing acidic silicate, and sol-gel silica obtained by the hydrolysis of an organic silane compound (for example, alkoxysilane).

As the silica base particles, from the viewpoint of charge distribution narrowing, for example, sol-gel silica is preferable.

Coating Structure

The coating structure consisting of the reaction product of the trifunctional silane compound has lower density compared to the silica base particles and has a pore structure. In addition, the coating structure consisting of the reaction product of the trifunctional silane compound has high affinity with the molybdenum nitrogen-containing compound. Presumably, accordingly, the molybdenum nitrogen-containing compound may enter into the coating structure (that is, into the pores of the pore structure), which may make the silica particles (S) have a relatively high content of the molybdenum nitrogen-containing compound.

The molybdenum nitrogen-containing compound that tends to be positively charged adheres to the surface of the silica base particles that tends to be negatively charged, which brings about an effect of canceling out an excess of negative charge of the silica base particles. The molybdenum nitrogen-containing compound has adhered to the inside of the coating structure (for example, preferably to the inside of pores of the pore structure) within the surface of the silica particles (S). Accordingly, the charge distribution of the silica particles (S) does not widen toward the positive charge side, and an excess of negative charge of the silica base particles is canceled out, which makes it possible to narrow the charge distribution of the silica particles (S).

The trifunctional silane compound is, for example, preferably a compound that does not contain N (nitrogen element). As the trifunctional silane compound, for example, a compound represented by Formula (S) is preferable.

RSiX₃ Formula (S)

In Formula (S), R represents a hydrocarbon group having 1 or more and 6 or less carbon atoms, and three X's each independently represent a hydroxyl group or a hydrolyzable group.

Examples of the reaction product of the trifunctional silane compound include a reaction product represented by Formula (S) in which some or all of X's are substituted with a OH group; a reaction product represented by Formula (S) in which some or all of the groups formed by the substitution of X with a OH group are polycondensed; and a reaction product represented by Formula (S) in which some or all of the groups formed by the substitution of X are polycondensed with a OH group and a SiOH group of the silica base particles.

Examples of the hydrocarbon group having 1 or more and 6 or less carbon atoms represented by R in Formula (S) include an aliphatic hydrocarbon group and a phenyl group. The hydrogen atom of the aliphatic hydrocarbon group may be substituted with a halogen atom. The hydrogen atom of the phenyl group may be substituted with a halogen atom.

In a case where R represents an aliphatic hydrocarbon group, the aliphatic hydrocarbon group may be linear, branched, or cyclic. The aliphatic hydrocarbon group is, for example, preferably linear or branched. The aliphatic hydrocarbon group may be saturated or unsaturated. The aliphatic hydrocarbon group is, for example, preferably a saturated aliphatic hydrocarbon group, that is, an alkyl group.

Examples of the linear alkyl group having 1 or more and 6 or less carbon atoms include a methyl group, an ethyl group, a n-propyl group, a n-butyl group, a n-pentyl group, and a n-hexyl group.

Examples of the branched alkyl group having 3 or more and 6 or less carbon atoms include an isopropyl group, an isobutyl group, a sec-butyl group, a tert-butyl group, an isopentyl group, a neopentyl group, a tert-pentyl group, an isohexyl group, a sec-hexyl group, and a tert-hexyl group.

Examples of the cyclic alkyl group having 3 or more and 6 or less carbon atoms include a cyclopropyl group, a cyclobutyl group, a cyclopentyl group, a cyclohexyl group, and a polycyclic alkyl group composed of these monocyclic alkyl groups linked to each other.

R in Formula (S) is, for example, preferably a linear alkyl group having 1 or more and 6 or less carbon atoms or a branched alkyl group having 3 or more and 6 or less carbon atoms, more preferably a linear alkyl group having 1 or more and 4 or less carbon atoms, and even more preferably a methyl group or an ethyl group.

Examples of the hydrolyzable group represented by X in Formula (S) include an alkoxy group. Examples of the alkoxy group include a linear, branched, or cyclic alkoxy group having 1 or more and 6 or less carbon atoms. The hydrogen atom of the alkoxy group may be substituted with a halogen atom.

Examples of the linear alkoxy group having 1 or more and 6 or less carbon atoms include a methoxy group, an ethoxy group, a n-propoxy group, a n-butoxy group, a n-pentyloxy group, and a n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Three X's in Formula (S), for example, preferably each independently represent a linear alkoxy group having 1 or more and 6 or less carbon atoms or a branched alkoxy group having 3 or more and 6 or less carbon atoms, more preferably each independently represent a linear alkoxy group having 1 or more and 4 or less carbon atoms, and even more preferably each independently represent a methoxy group or an ethoxy group.

Examples of the trifunctional silane compound include methyltrimethoxysilane, ethyltrimethoxysilane, propyltrimethoxysilane, butyltrimethoxysilane, hexyltrimethoxysilane, methyltriethoxysilane, ethyltriethoxysilane, butyltriethoxysilane, hexyltriethoxysilane, phenyltrimethoxysilane, phenyltriethoxysilane, and the like. One trifunctional silane compound may be used alone, or two or more kinds trifunctional silane compounds may be used in combination.

As the trifunctional silane compound, for example, alkyltrialkoxysilane is preferable,
at least one trifunctional silane compound selected from the group consisting of alkyltrimethoxysilane and alkyltriethoxysilane having an alkyl group having 1 or more and 6 or less carbon atoms is more preferable;
at least one trifunctional silane compound selected from the group consisting of alkyltrimethoxysilane and alkyltriethoxysilane having an alkyl group having 1 or more and 4 or less carbon atoms is more preferable; and
at least one trifunctional silane compound selected from the group consisting of methyltrimethoxysilane, ethyltrimethoxysilane, methyltriethoxysilane, and ethyltriethoxysilane is particularly preferable.

The mass ratio of the coating structure configured with the reaction product of the trifunctional silane compound to the total amount of the silica particles (S) is, for example, preferably 5.5% by mass or more and 30% by mass or less, and more preferably 7% by mass or more and 22% by mass or less.

Molybdenum Nitrogen-Containing Compound

The molybdenum nitrogen-containing compound is a nitrogen element-containing compound containing a molybdenum element, excluding ammonia and a compound that is in a gaseous state at a temperature of 25° C. or lower.

The molybdenum nitrogen-containing compound preferably has adhered, for example, to the inside of the coating structure (that is, to the inside of the pore structure) consisting of the reaction product of the trifunctional silane compound. One molybdenum nitrogen-containing compound or two or more molybdenum nitrogen-containing compounds may be used.

From the viewpoint of charge distribution narrowing and charge distribution retentivity, the molybdenum nitrogen-containing compound is, for example, preferably at least one compound selected from the group consisting of a quaternary ammonium salt containing a molybdenum element (particularly, a quaternary ammonium salt of molybdic acid) and a mixture of a quaternary ammonium salt and a metal oxide containing a molybdenum element. In the quaternary ammonium salt containing a molybdenum element, the bond between an anion containing a molybdenum element and a quaternary ammonium cation is strong. Therefore, the quaternary ammonium salt containing a molybdenum element has high charge distribution retentivity.

As the molybdenum nitrogen-containing compound, for example, a compound represented by Formula (1) is preferable.

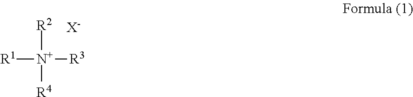

In Formula (1), R¹, R², R³, and R⁴ each independently represent a hydrogen atom, an alkyl group, an aralkyl group, or an aryl group, and X⁻ represents an anion containing a molybdenum element. Here, at least one of R¹, R², R³, or R⁴ represents an alkyl group, an aralkyl group, or an aryl group. Furthermore, two or more out of R¹, R², R³, and R⁴ may be linked to form an aliphatic ring, an aromatic ring, or a heterocycle. The alkyl group, the aralkyl group, and the aryl group may have a substituent.

Examples of the alkyl group represented by R¹ to R⁴ include a linear alkyl group having 1 or more and 20 or less carbon atoms and a branched alkyl group having 3 or more and 20 or less carbon atoms. Examples of the linear alkyl group having 1 or more and 20 or less carbon atoms include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, and the like. Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, and the like.

As the alkyl group represented by R¹ to R⁴, for example, an alkyl group having 1 or more and 15 or less carbon atoms, such as a methyl group, an ethyl group, a butyl group, or a tetradecyl group, is preferable.

Examples of the aralkyl group represented by R¹ to R⁴ include an aralkyl group having 7 or more and 30 or less carbon atoms. Examples of the aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, a phenyl-cycloheptylmethyl group, and the like.

As the aralkyl group represented by R¹ to R⁴, for example, an aralkyl group having 7 or more and 15 or less carbon atoms, such as a benzyl group, a phenylethyl group, a phenylpropyl group, or a 4-phenylbutyl group, is preferable.

Examples of the aryl group represented by R¹ to R⁴ include an aryl group having 6 or more and 20 or less carbon atoms. Examples of the aryl group having 6 to 20 carbon atoms include a phenyl group, a pyridyl group, a naphthyl group, and the like.

As the aryl group represented by R¹ to R⁴, for example, an aryl group having 6 or more and 10 or less carbon atoms, such as a phenyl group, is preferable.

Examples of the ring formed of two or more of R¹, R², R³, and R⁴ linked to each other include an alicyclic ring having 2 or more and 20 or less carbon atoms, a heterocyclic amine having 2 or more and 20 or less carbon atoms, and the like.

R¹, R², R³, and R⁴ may each independently have a substituent. Examples of the substituent include a nitrile group, a carbonyl group, an ether group, an amide group, a siloxane group, a silyl group, an alkoxysilane group, and the like.

It is preferable that R¹, R², R³, and R⁴ each independently represent, for example, an alkyl group having 1 or more and 16 or less carbon atoms, an aralkyl group having 7 or more and 10 or less carbon atoms, or an aryl group having 6 or more and 20 or less carbon atoms.

The anion containing a molybdenum element represented by X⁻ is, for example, preferably a molybdate ion, more preferably a molybdate ion having tetravalent or hexavalent molybdenum, and still more preferably a molybdate ion having hexavalent molybdenum. Specifically, as the molybdate ion, for example, MoO₄²⁻, Mo₂O₇²⁻, Mo₃O₁₀²⁰, Mo₄O₁₃, Mo₇O₂₄²⁻, and Mo₈O₂₆⁴⁻ are preferable.

From the viewpoint of charge distribution narrowing and charge distribution retentivity, the total number of carbon atoms in the compound represented by Formula (1) is, for example, preferably 18 or more and 35 or less, and more preferably 20 or more and 32 or less.

Examples of the compound represented by Formula (1) will be shown below. The present exemplary embodiment is not limited thereto.

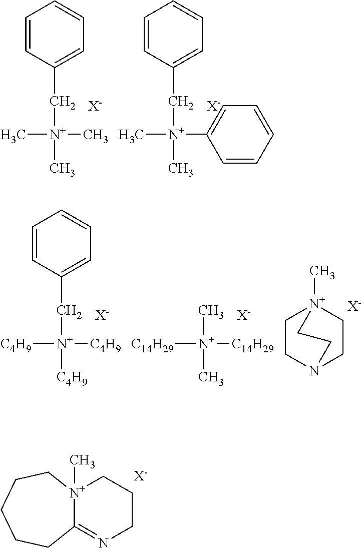

Examples of the quaternary ammonium salt containing a molybdenum element include a quaternary ammonium salt of molybdic acid such as [N⁺(CH)₃(C₁₄C₂₉)₂]₄Mo₈O₂₈⁴⁻, [N⁺(C₄H₉)₂(C₆H₆)₂]₂Mo₂O₇²⁻, [N⁺(CH₃)₂(CH₂C₆H₆)(CH₂)₁₇CH₃]₂MoO₄²⁻, and [N⁺(CH₃)₂(CH₂C₆H₆)(CH₂)₁₅CH₃]₂MoO₄²⁻.

Examples of the metal oxide containing a molybdenum element include a molybdenum oxide (molybdenum trioxide, molybdenum dioxide, or Mo₉O₂₆), a molybdic acid alkali metal salt (such as lithium molybdate, sodium molybdate, or potassium molybdate), a molybdenum alkaline earth metal salt (such as magnesium molybdate or calcium molybdate) and other composite oxides (such as Bi₂O₃·2MoO₃ or γ-Ce₂Mo₃O₁₃).

As the molybdenum nitrogen-containing compound, for example, the compound with CAS Registry Number 117342-25-3 is particularly preferable. The compound with CAS Registry Number 117342-25-3 has TP-415, 1-Tetradecanaminium, N,N-dimethyl-N-tetradecyl-, hexa-.mu.-oxotetra-.mu.3-oxodi-.mu.5-oxotetradecaoxooctamolybdate(4-) (4:1) as other names.

In a case where the specific silica particles (S) are heated at a temperature in a range of 300° C. or higher and 600° C. or lower, a molybdenum nitrogen-containing compound is detected. The molybdenum nitrogen-containing compound can be detected by heating at a temperature of 300° C. or higher and 600° C. or lower in an inert gas. For example, the molybdenum nitrogen-containing compound is detected using a heating furnace-type drop-type pyrolysis gas chromatography mass spectrometer using He as a carrier gas. Specifically, by introducing silica particles in an amount of 0.1 mg or more and 10 mg or less into a pyrolysis gas chromatography mass spectrometer, it is possible to check whether or not the silica particles contain a molybdenum nitrogen-containing compound from the MS spectrum of the detected peak. Examples of components generated by pyrolysis from the silica particles containing a molybdenum nitrogen-containing compound include a primary, secondary, or tertiary amine represented by Formula (2) and an aromatic nitrogen compound. R¹, R², and R³ in Formula (2) have the same definition as R¹, R², and R³ in Formula (1) respectively. In a case where the molybdenum nitrogen-containing compound is a quaternary ammonium salt, some of the side chains thereof are detached by pyrolysis at 600° C., and a tertiary amine is detected.

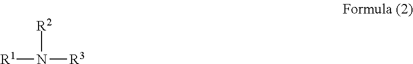

Nitrogen Element-Containing Compound that Does Not Contain Molybdenum Element

In the silica particles (S), a nitrogen element-containing compound that does not contain a molybdenum element may adhere to the coating structure (for example, preferably the pore structure) of the reaction product of the trifunctional silane compound.

The nitrogen element-containing compound that does not contain a molybdenum element may be introduced into the silica particles (S), for example, for the purpose of controlling the charging properties or the degree of hydrophobicity of the silica particles (S). Additionally incorporating the nitrogen element-containing compound that does not contain a molybdenum element into the reaction solution in the attaching step, which will be described later, enables the nitrogen element-containing compound that does not contain a molybdenum element to adhere to the inside of the coating structure (for example, preferably to the inside of pores of the pore structure) of the reaction product of the trifunctional silane compound.

Examples of the nitrogen element-containing compound that does not contain a molybdenum element include at least one compound selected from the group consisting of a quaternary ammonium salt, a primary amine compound, a secondary amine compound, a tertiary amine compound, an amide compound, an imine compound, and a nitrile compound. The nitrogen element-containing compound that does not contain a molybdenum element is, for example, preferably a quaternary ammonium salt.

Specific examples of the primary amine compound include phenethylamine, toluidine, catecholamine, and 2,4,6-trimethylaniline.

Specific examples of the secondary amine compound include dibenzylamine, 2-nitrodiphenylamine, and 4-(2-octylamino)diphenylamine.

Specific examples of the tertiary amine compound include 1,8-bis(dimethylamino)naphthalene, N,N-dibenzyl-2-aminoethanol, and N-benzyl-N-methylethanolamine.

Specific examples of the amide compound include N-cyclohexyl-p-toluenesulfonamide, 4-acetamide-1-benzylpiperidine, and N-hydroxy-3-[1-(phenylthio)methyl-1H-1,2,3-triazol-4-yl]benzamide.

Specific examples of the imine compound include diphenylmethaneimine, 2,3-bis(2,6-diisopropylphenylimino)butane, and N,N′-(ethane-1,2-diylidene)bis(2,4,6-trimethylaniline).

Specific examples of the nitrile compound include 3-indoleacetonitrile, 4-[(4-chloro-2-pyrimidinyl)amino]benzonitrile, and 4-bromo-2,2-diphenylbutyronitrile.

Examples of the quaternary ammonium salt include a compound represented by Formula (AM). One compound represented by Formula (AM) or two or more compounds represented by Formula (AM) may be used.

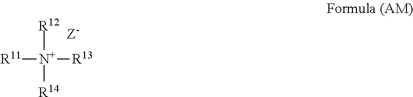

In formula (AM), R¹¹, R¹², R¹³, and R¹⁴ each independently represent a hydrogen atom, an alkyl group, an aralkyl group, or an aryl group, and Z⁻ represents an anion. Here, at least one of R¹¹, R¹², R¹³, or R¹⁴ represents an alkyl group, an aralkyl group, or an aryl group. Furthermore, two or more out of R¹¹, R¹², R¹³, and R¹⁴ may be linked to form an aliphatic ring, an aromatic ring, or a heterocycle. The alkyl group, the aralkyl group, and the aryl group may have a substituent.

Examples of the alkyl group represented by R¹¹ to R¹⁴ include a linear alkyl group having 1 or more and 20 or less carbon atoms and a branched alkyl group having 3 or more and 20 or less carbon atoms. Examples of the linear alkyl group having 1 or more and 20 or less carbon atoms include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, and the like. Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, and the like.

As the alkyl group represented by R¹¹ to R¹⁴, for example, an alkyl group having 1 or more and 15 or less carbon atoms, such as a methyl group, an ethyl group, a butyl group, or a tetradecyl group, is preferable.

Examples of the aralkyl group represented by R¹¹ to R¹⁴ include an aralkyl group having 7 or more and 30 or less carbon atoms. Examples of the aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, a phenyl-cycloheptylmethyl group, and the like.

As the aralkyl group represented by R¹¹ to R¹⁴, for example, an aralkyl group having 7 or more and 15 or less carbon atoms, such as a benzyl group, a phenylethyl group, a phenylpropyl group, or a 4-phenylbutyl group, is preferable.

Examples of the aryl group represented by R¹¹ to R¹⁴ include an aryl group having 6 or more and 20 or less carbon atoms. Examples of the aryl group having 6 to 20 carbon atoms include a phenyl group, a pyridyl group, a naphthyl group, and the like.

As the aryl group represented by R¹¹ to R¹⁴, for example, an aryl group having 6 or more and 10 or less carbon atoms, such as a phenyl group, is preferable.

Examples of the ring formed of two or more of R¹¹, R¹², R¹³, and R¹⁴ linked to each other include an alicyclic ring having 2 or more and 20 or less carbon atoms, a heterocyclic amine having 2 or more and 20 or less carbon atoms, and the like.

R¹¹, R¹², R¹³, and R¹⁴ may each independently have a substituent. Examples of the substituent include a nitrile group, a carbonyl group, an ether group, an amide group, a siloxane group, a silyl group, an alkoxysilane group, and the like.

It is preferable that R¹¹, R¹², R¹³, and R¹⁴ each independently represent, for example, an alkyl group having 1 or more and 16 or less carbon atoms, an aralkyl group having 7 or more and 10 or less carbon atoms, or an aryl group having 6 or more and 20 or less carbon atoms.

The anion represented by Z⁻ may be any of an organic anion and an inorganic anion.

Examples of the organic anion include a polyfluoroalkylsulfonate ion, a polyfluoroalkylcarboxylate ion, a tetraphenylborate ion, an aromatic carboxylate ion, an aromatic sulfonate ion (such as a 1-naphthol-4-sulfonate ion), and the like.

Examples of the inorganic anion include OH⁻, F⁻, Fe(CN)₆³⁻, Cl⁻, Br⁻, NO₂⁻, NO₃⁻, CO₃²⁻, PO₄³⁻, SO₄²⁻, and the like.

From the viewpoint of charge distribution narrowing and charge distribution retentivity, the total number of carbon atoms in the compound represented by Formula (AM) is, for example, preferably 18 or more and 35 or less, and more preferably 20 or more and 32 or less.

Examples of the compound represented by Formula (AM) will be shown below. The present exemplary embodiment is not limited thereto.

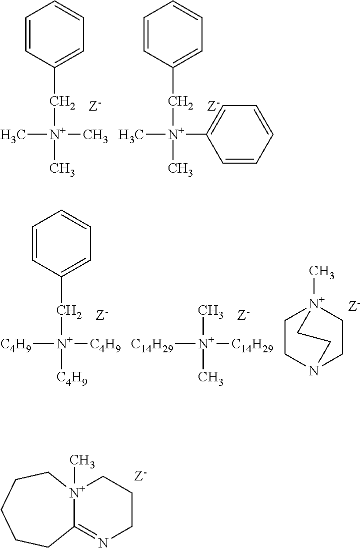

From the viewpoint of charge distribution narrowing and charge distribution retentivity, the total content of the molybdenum nitrogen-containing compound and the nitrogen element-containing compound that does not contain a molybdenum element, which are contained in the silica particles (S), the total content being expressed as a mass ratio N/Si of a nitrogen element to a silicon element, is, for example, preferably 0.005 or more and 0.50 or less, more preferably 0.008 or more and 0.45 or less, even more preferably 0.015 or more and 0.20 or less, and still more preferably 0.018 or more and 0.10 or less.

The mass ratio N/Si in the silica particles (S) is measured using an oxygen/nitrogen analyzer (for example, EMGA-920 manufactured by HORIBA, Ltd.) for a total of 45 seconds, and determined as a mass ratio of N atoms to Si atoms (N/Si). As a pretreatment, the sample is dried in a vacuum at 100° C. for 24 hours or more to remove impurities such as ammonia.

A total extraction amount X of the molybdenum nitrogen-containing compound and the nitrogen element-containing compound that does not contain a molybdenum element, which are extracted from the silica particles (S) by using a mixed solution of ammonia/methanol, is, for example, preferably 0.1% by mass or more with respect to the mass of the silica particles (S). In addition, the total extraction amount X of the molybdenum nitrogen-containing compound and the nitrogen element-containing compound that does not contain a molybdenum element, which are extracted from the silica particles (S) by the mixed solution of ammonia/methanol, and a total extraction amount Y of the molybdenum nitrogen-containing compound and the nitrogen element-containing compound that does not contain a molybdenum element, which are extracted from the silica particles (S) by water (just as X, Y is a mass ratio to the mass of the silica particles (S)) preferably satisfy, for example, Y/X<0.3.

The above relationship shows that the nitrogen element-containing compound contained in the silica particles (S) has the properties of not being easily dissolved in water, that is, the properties of not being easily adsorbed onto the moisture in the air. Therefore, in a case where the above relationship is satisfied, the silica particles (S) are excellent in charge distribution narrowing and charge distribution retentivity.

The extraction amount X is, for example, preferably 0.25% by mass or more and 6.5% by mass or less with respect to the mass of the silica particles (S). Ideally, the ratio Y/X of the extraction amount Y to the extraction amount X is 0.

The extraction amount X and the extraction amount Y are measured by the following method.

First, the silica particles are analyzed with a thermogravimetric analyzer (for example, a gas chromatography mass spectrometer manufactured by Netch Japan Co., Ltd.) at a temperature of 400° C., the mass fractions of compounds in which a hydrocarbon having one or more carbon atoms forms a covalent bond with a nitrogen atom to the silica particles are measured, added up, and adopted as W1.

The silica particles (1 part by mass) are added to 30 parts by mass of an ammonia/methanol solution (manufactured by Sigma-Aldrich Co., LLC., mass ratio of ammonia/methanol=1/5.2) at a liquid temperature of 25° C. and treated with ultrasonic waves for 30 minutes, and then silica powder and an extract are separated. The separated silica particles are dried in a vacuum dryer at 100° C. for 24 hours. Then, by using a thermogravimetric analyzer, the mass fractions of compounds in which a hydrocarbon having one or more carbon atoms forms a covalent bond with a nitrogen atom to the silica particles are measured at 400° C., added up, and adopted as W2.

The silica particles (1 part by mass) are added to 30 parts by mass of water at a liquid temperature of 25° C. and treated with ultrasonic waves for 30 minutes, and then the silica particles and an extract are separated. The separated silica particles are dried in a vacuum dryer at 100° C. for 24 hours. Then, by using a thermogravimetric analyzer, the mass fractions of compounds in which a hydrocarbon having one or more carbon atoms forms a covalent bond with a nitrogen atom to the silica particles are measured at 400° C., added up, and adopted as W3.

From W1 and W2, extraction amount X=W1−W2 is calculated.

From W1 and W3, extraction amount Y=W1−W3 is calculated.

Hydrophobic Structure

In the silica particles (S), a hydrophobic structure (a structure obtained by treating silica particles with a hydrophobic agent) may adhere to the coating structure consisting of the reaction product of the trifunctional silane compound.

As the hydrophobic agent, a compound other than the trifunctional silane compound is used. Examples of the hydrophobic agent include a silazane compounds such as hexamethyldisilazane or tetramethyldisilazane, a titanate-based coupling agent, and an aluminum-based coupling agent.

Characteristics of Silica Particles (S)

From the viewpoint of charge distribution narrowing and charge distribution retentivity, the silica particles (S) preferably have, for example, the following characteristics.

Average Circularity, Average Primary Particle Size, and Particle Size Distribution Index

The average circularity of the silica particles (S) is, for example, preferably 0.60 or more and 0.96 or less, more preferably 0.65 or more and 0.94 or less, even more preferably 0.70 or more and 0.92 or less, and still more preferably 0.75 or more and 0.90 or less.

The average primary particle size of the silica particles (Silica particles (S)) is, for example, preferably 10 nm or more and 200 nm or less, more preferably 20 nm or more and 150 nm or less, even more preferably 30 nm or more and 120 nm or less, and still more preferably 40 nm or more and 100 nm or less.

The particle size distribution index of the silica particles (S) is, for example, preferably 1.1 or more and 2.0 or less, and more preferably 1.15 or more and 1.6 or less.

The method of measuring the average circularity, average primary particle size, and particle size distribution index of the silica particles (S) is as follows.

The silica particles are imaged using a scanning electron microscope (SEM) (manufactured by Hitachi High-Tech Corporation, S-4800) at 40,000× magnification. At least 200 silica particles are analyzed by the image processing/analyzing software WinRoof (MITANI CORPORATION). For each of the primary particles, an equivalent circular diameter, an area, and a perimeter are calculated, and circularity=4π×(area of particle image)÷(perimeter of particle image)² is calculated. In the circularity distribution, the circularity below which the cumulative percentage of particles having a lower circularity reaches 50% is defined as an average circularity. In the distribution of equivalent circular diameter, the equivalent circular diameter below which the cumulative percentage of particles having smaller equivalent circular diameter reaches 50% is defined as an average primary particle size. In the distribution of equivalent circular diameter, the particle size below which the cumulative percentage of particles having a smaller equivalent circular diameter reaches 16% is defined as D16, the particle size below which the cumulative percentage of particles having a smaller equivalent circular diameter reaches 84% is defined as D84, and particle size distribution index=(D84/D16)^{0.5} is calculated.

Degree of Hydrophobicity

A degree of hydrophobicity of the silica particles (S) is, for example, preferably 10% or more and 60% or less, more preferably 20% or more and 55% or less, and even more preferably 28% or more and 53% or less.

The method of measuring the degree of hydrophobicity of the silica particles is as follows.

Silica particles (0.2% by mass) are added to 50 ml of deionized water. While the mixture is being stirred with a magnetic stirrer, methanol is added dropwise thereto from a burette, and the mass fraction of methanol in the mixed solution of methanol/water at a point in time when the entirety of the sample is precipitated is determined and adopted as a degree of hydrophobicity.

Volume Resistivity

A volume resistivity R of the silica particles (S) is, for example, preferably 1.0×10⁷ Ω·cm or more and 1.0×10^{12.5} Ω·cm or less, more preferably 1.0×10^{7.5} Ω·cm or more and 1.0×10¹² Ω·cm or less, even more preferably 1.0×10⁸ Ω·cm or more and 1.0×10^{11.5} Ω·cm or less, and still more preferably 1.0×10⁹ Ω·cm or more and 1.0×10¹¹ Ω·cm or less. The volume resistivity R of the silica particles (S) can be adjusted by the content of the molybdenum nitrogen-containing compound.

In a case where Ra represents a volume resistivity of the silica particles (S) before baking at 350° C., and Rb represents a volume resistivity of the silica particles (S) after baking at 350° C., a ratio Ra/Rb is, for example, preferably 0.01 or more and 0.8 or less, and more preferably 0.015 or more and 0.6 or less.

The volume resistivity Ra (having the same definition as the aforementioned volume resistivity R) of the silica particles (S) before baking at 350° C. is, for example, preferably 1.0×10⁷ Ω·cm or more and 1.0×10^{12.5} Ω·cm or less, more preferably 1.0×10^{7.5} Ω·cm or more and 1.0×10¹² Ω·cm or less, even more preferably 1.0×10⁸ Ω·cm or more and 1.0×10^{11.5} Ω·cm or less, and still more preferably 1.0×10⁹ Ω·cm or more and 1.0×10¹¹ Ω·cm or less.

The baking at 350° C. is a process of heating the silica particles (A) up to 350° C. at a heating rate of 10° C./min in a nitrogen environment, keeping the silica particles (A) at 350° C. for 3 hours, and cooling the silica particles (A) to room temperature (25° C.) at a cooling rate of 10° C./min.

The volume resistivity of the silica particles (S) is measured as follows in an environment at a temperature of 20° C. and a relative humidity of 50%.

The silica particles (S) are placed on the surface of a circular jig on which a 20 cm² electrode plate is disposed, such that a silica particle layer having a thickness of about 1 mm or more and 3 mm or less is formed. A 20 cm² electrode plate is placed on the silica particle layer such that the silica particle layer is interposed between the electrode plates, and in order to eliminate voids between the silica particles, a pressure of 0.4 MPa is applied on the electrode plate. A thickness L (cm) of the silica particle layer is measured. By using an impedance analyzer (manufactured by Solartron Analytical) connected to both the electrodes placed on and under the silica particle layer, a Nyquist plot in a frequency range of 10⁻³ Hz or more and 10⁶ Hz or less is obtained. On the assumption that there are three resistance components, bulk resistance, particle interface resistance, and electrode contact resistance, the plot is fitted to an equivalent circuit, and a bulk resistance R (Ω) is determined. From the bulk resistance R (Ω) and the thickness L (cm) of the silica particle layer, a volume resistivity p (Ω·cm) of the silica particles is calculated by the equation of ρ=R/L.

Amount of OH Groups

The amount of OH groups in the silica particles (S) is, for example, preferably 0.05 OH groups/nm² or more and 6 OH groups/nm² or less, more preferably 0.1 OH groups/nm² or more and 5.5 OH groups/nm² or less, more preferably 0.15 OH groups/nm² or more and 5 OH groups/nm² or less, still more preferably 0.2 OH groups/nm² or more and 4 OH groups/nm² or less, and yet more preferably 0.2 OH groups/nm² or more and 3 OH groups/nm² or less.

The amount of OH groups in the silica particles is measured as follows by the Sears method.

Silica particles (1.5 g) are added to a mixed solution of 50 g of water/50 g of ethanol, and the mixture is stirred with an ultrasonic homogenizer for 2 minutes, thereby preparing a dispersion. While the dispersion is being stirred in an environment at 25° C., 1.0 g of a 0.1 mol/L aqueous hydrochloric acid solution is added dropwise thereto, thereby obtaining a test liquid. The test liquid is put in an automatic titration device, potentiometric titration using a 0.01 mol/L aqueous sodium hydroxide solution is performed, and a differential curve of the titration curve is created. In the inflection point where the differential value of the titration curve is 1.8 or more, the titration amount by which the titration amount of the 0.01 mol/L aqueous sodium hydroxide solution is maximized is denoted by E.

From the following equation, a surface silanol group density ρ (number of surface silanol groups/nm²) in the silica particles is calculated and adopted as the amount of OH groups in the silica particles.

ρ=((0.01×E−0.1)×NA/1,000)/(M×S_{BET}×10¹⁸) Equation:

E: titration amount by which the titration amount of the 0.01 mol/L aqueous sodium hydroxide solution is maximized in the inflection point where the differential value of the titration curve is 1.8 or more, NA: Avogadro's number, M: amount of silica particles (1.5 g), S_{BET}: specific surface area of silica particles (m²/g) measured by the three-point BET nitrogen adsorption method (relative equilibrium pressure is 0.3).

Ratio N_{Mo}/N_{Si} of Net Intensity

In the silica particles (S), from the viewpoint of charge distribution narrowing and charge distribution retentivity, a ratio N_{Mo}/N_{Si} of Net intensity N_{Mo} of the molybdenum element measured by X-ray fluorescence analysis to Net intensity N_{Si} of the silicon element measured by X-ray fluorescence analysis is, for example, preferably 0.035 or more and 0.45 or less. The ratio N_{Mo}/N_{Si} is, for example, more preferably 0.05 or more, even more preferably 0.07 or more, and particularly preferably 0.10 or more. The ratio N_{Mo}/N_{Si} is, for example, more preferably 0.40 or less, even more preferably 0.35 or less, and particularly preferably 0.30 or less.

From the viewpoint of charge distribution narrowing and charge distribution retentivity, the Net intensity N_{Mo} of the molybdenum element of the silica particles (S) is, for example, preferably 5 kcps or more and 75 kcps or less, more preferably 7 kcps or more and 55 kcps or less, even more preferably 8 kcps or more and 50 kcps or less, and still more preferably 10 kcps or more and 40 kcps or less.

The method of measuring the Net intensity N_{Mo} of the molybdenum element and the Net intensity N_{Si} of the silicon element in the silica particles is as follows.

Approximately 0.5 g of silica particles are compressed using a compression molding machine by being pressed under a load of 6 tons for 60 seconds, thereby preparing a disk having a diameter of 50 mm and a thickness of 2 mm. This disk is used as a sample for qualitative quantitative elemental analysis performed under the following conditions by using a scanning X-ray fluorescence spectrometer (XRF-1500, manufactured by Shimadzu Corporation), and Net intensity of each of the molybdenum element and the silicon element is determined (unit: kilo counts per second, kcps).
Tube voltage: 40 kV
Tube current: 90 mA
Measurement area (analysis diameter): diameter of 10 mm
Measurement time: 30 minutes
Anticathode: rhodium

Pore Diameter

For example, in a pore size distribution curve obtained by a nitrogen adsorption method, the silica particles (S) preferably have a first peak in a range of pore diameter of 0.01 nm or more and 2 nm or less and a second peak in a range of pore diameter of 1.5 nm or more and 50 nm or less, more preferably have a second peak in a range of pore diameter of 2 nm or more and 50 nm or less, even more preferably have a second peak in the range of pore diameter of 2 nm or more and 40 nm or less, and particularly preferably have a second peak in a range of pore diameter of 2 nm or more and 30 nm or less.

In a case where the first peak and the second peak are in the above range, the molybdenum nitrogen-containing compound enters deeply into the pores of the coating structure, and the charge distribution is narrowed.

The method of obtaining the pore size distribution curve by the nitrogen adsorption method is as follows.

The silica particles are cooled to the temperature of liquid nitrogen (−196° C.), nitrogen gas is introduced, and the amount of nitrogen gas adsorbed is determined by a constant volume method or a gravimetric method. The pressure of nitrogen gas introduced is slowly increased, and the amount of nitrogen gas adsorbed is plotted for each equilibrium pressure, thereby creating an adsorption isotherm. From the adsorption isotherm, a pore size distribution curve in which the ordinate shows a frequency and the abscissa shows a pore diameter is obtained by the equation of the BJH method. Then, from the obtained pore size distribution curve, an integrated pore volume distribution in which the ordinate shows a volume and the abscissa shows a pore diameter is obtained, and the position of peak of the pore diameter is checked.

Aspect (A) and Aspect (B)

From the viewpoint of charge distribution narrowing and charge distribution retentivity, the silica particles (S) preferably satisfy, for example, any of the following aspects (A) and (B).
Aspect (A): an aspect in which in a case where A represents a pore volume of pores having a diameter of 1 nm or more and 50 nm or less determined from a pore size distribution curve obtained by a nitrogen adsorption method before baking at 350° C., and B represents a pore volume of pores having a diameter of 1 nm or more and 50 nm or less determined from a pore size distribution curve obtained by a nitrogen adsorption method after baking at 350° C., B/A is 1.2 or more and 5 or less, and B is 0.2 cm³/g or more and 3 cm³/g or less.

Hereinafter, “pore volume A of pores having a diameter of 1 nm or more and 50 nm or less determined from a pore size distribution curve obtained by a nitrogen adsorption method before baking at 350° C.” will be called “pore volume A before baking at 350° C.”, and “pore volume B of pores having a diameter of 1 nm or more and 50 nm or less determined from a pore size distribution curve obtained by a nitrogen adsorption method after baking at 350° C.” will be called “pore volume B after baking at 350° C.”.

The baking at 350° C. is a process of heating the silica particles (A) up to 350° C. at a heating rate of 10° C./min in a nitrogen environment, keeping the silica particles (A) at 350° C. for 3 hours, and cooling the silica particles (A) to room temperature (25° C.) at a cooling rate of 10° C./min.

The method of measuring the pore volume is as follows.

The silica particles are cooled to the temperature of liquid nitrogen (−196° C.), nitrogen gas is introduced, and the amount of nitrogen gas adsorbed is determined by a constant volume method or a gravimetric method. The pressure of nitrogen gas introduced is slowly increased, and the amount of nitrogen gas adsorbed is plotted for each equilibrium pressure, thereby creating an adsorption isotherm. From the adsorption isotherm, a pore size distribution curve in which the ordinate shows a frequency and the abscissa shows a pore diameter is obtained by the equation of the BJH method. From the obtained pore size distribution curve, an integrated pore volume distribution in which the ordinate shows a volume and the abscissa shows a pore diameter is obtained. From the obtained integrated pore volume distribution, an integral value of pore volumes of pores having a diameter in a range of 1 nm or more and 50 nm or less is calculated and adopted as “pore volume of pores having a diameter of 1 nm or more and 50 nm or less”.

The ratio B/A of the pore volume B after baking at 350° C. to the pore volume A before baking at 350° C. is, for example, preferably 1.2 or more and 5 or less, more preferably 1.4 or more and 3 or less, and even more preferably 1.4 or more and 2.5 or less.

The pore volume B after baking at 350° C. is, for example, preferably 0.2 cm³/g or more and 3 cm³/g or less, more preferably 0.3 cm³/g or more and 1.8 cm³/g or less, and even more preferably 0.6 cm³/g or more and 1.5 cm³/g or less.

The aspect (A) is an aspect in which a sufficient amount of the nitrogen element-containing compound is adsorbed onto at least some of the pores of the silica particles.
Aspect (B): an aspect in which in a case where C represents an integral value of signals observed in a range of chemical shift of −50 ppm or more and −75 ppm or less in a ²⁹Si solid-state nuclear magnetic resonance (NMR) spectrum obtained by a cross-polarization/magic angle spinning (CP/MAS) method (hereinafter, also called “Si-CP/MAS NMR spectrum”), and D represents an integral value of signals observed in a range of chemical shift of −90 ppm or more and −120 ppm or less in the same spectrum, a ratio C/D is 0.10 or more and 0.75 or less.

The Si-CP/MAS NMR spectrum can be obtained by measuring a sample by nuclear magnetic resonance spectroscopy under the following conditions.
Spectrometer: AVANCE 300 (manufactured by Bruker)
Resonance frequency: 59.6 MHz
Measurement nucleus: ²⁹Si
Measurement method: CPMAS method (using Bruker's standard ParC sequence cp.av)
Waiting time: 4 sec
Contact time: 8 ms
Number of times of integration: 2,048
Measurement temperature: room temperature (25° C., measured temperature)
Center frequency of observation: −3975.72 Hz
MAS rotation speed: 7.0 mm-6 kHz
Reference substance: hexamethylcyclotrisiloxane

The ratio C/D is, for example, preferably 0.10 or more and 0.75 or less, more preferably 0.12 or more and 0.45 or less, and even more preferably 0.15 or more and 0.40 or less.

In a case where the integral value of all signals in Si-CP/MAS NMR spectrum is regarded as 100%, the ratio of the integral value C (Signal ratio) of the signals observed in a range of chemical shift of −50 ppm or more and −75 ppm or less is, for example, preferably 5% or more, and more preferably 7% or more. The upper limit of the ratio of the integral value C of the signals is, for example, 60% or less.

Aspect (B) is an aspect having a low-density coating structure in which a sufficient amount of a nitrogen element-containing compound can be adsorbed onto at least a part of the surface of silica particles. The low-density coating structure is, for example, a coating structure consisting of a reaction product of a trifunctional silane compound, which is a SiO_{2/3}CH₃ layer, for example.

Manufacturing Method of Silica Particles (S)

An example of a manufacturing method of the silica particles (S) has a coating step of forming a coating structure consisting of a reaction product of a trifunctional silane compound on a surface of silica base particles, and an attaching step of attaching a molybdenum nitrogen-containing compound to the coating structure. Hereinafter, the above steps will be specifically described.

Silica Base Particles

The silica base particles are prepared, for example, by the following step (i) or step (ii).

Step (i): a step of mixing an alcohol-containing solvent with silica base particles to prepare a silica base particle suspension.

Step (ii): a step of granulating silica base particles by a sol-gel method to obtain a silica base particle suspension.

The silica base particles used in the step (i) may be dry silica or wet silica. Specific examples thereof include sol-gel silica, aqueous colloidal silica, alcoholic silica, fumed silica, molten silica, and the like.

The alcohol-containing solvent used in the step (i) may be a solvent composed only of an alcohol or a mixed solvent of an alcohol and other solvents. In the case of the mixed solvent, the proportion of the alcohol is, for example, preferably 80% by mass or more, and more preferably 85% by mass or more.

Examples of the alcohol configuring the alcohol-containing solvent include lower alcohols such as methanol, ethanol, 1-propanol, isopropanol, 1-butanol (n-butyl alcohol), 2-methyl-1-propanol (isobutyl alcohol), 2-butanol (sec-butyl alcohol), and 2-methyl-2-propanol (tert-butyl alcohol). Among these, from the viewpoint of low reactivity with tetraalkoxysilane and silica, dispersion stability of silica particles, high removability in a drying step, and the like, for example, at least one alcohol selected from the group consisting of methanol, ethanol, 1-propanol, 2-propanol, and 2-methyl-2-propanol is preferable.

Examples of solvents other than the alcohol configuring the alcohol-containing solvent include water; ketones such as acetone, methyl ethyl ketone, and methyl isobutyl ketone; cellosolves such as methyl cellosolve, ethyl cellosolve, butyl cellosolve, and cellosolve acetate; ethers such as dioxane and tetrahydrofuran; and the like.

As the solvent alcohol-containing solvent, for example, a mixed solvent of a lower alcohol and water is preferable, and a mixed solvent of water and at least one alcohol selected from the group consisting of methanol, ethanol, 1-propanol, 2-propanol, and 2-methyl-2-propanol is more preferable. The proportion of the alcohol in such a mixed solvent is, for example, preferably 80% by mass or more, and more preferably 85% by mass or more.

In the present disclosure, the step (ii) is also called “granulating step”. It is preferable that an example of the manufacturing method of the silica particles (S) further include, for example, the granulating step before the coating step. Details of the granulating step will be described below.

Granulating Step

The granulating step is a step of granulating silica base particles by a sol-gel method. By the granulating step, a silica base particle suspension to be used in the coating step is obtained.

The granulating step is, for example, preferably a sol-gel method including an alkali catalyst solution preparation step of preparing an alkali catalyst solution composed of an alcohol-containing solvent containing an alkali catalyst and a silica base particle generation step of supplying tetraalkoxysilane and an alkali catalyst to the alkali catalyst solution to generate silica base particles.

The alkali catalyst solution preparation step is, for example, preferably a step of preparing an alcohol-containing solvent and mixing the solvent with an alkali catalyst to obtain an alkali catalyst solution.

The alcohol-containing solvent may be a solvent composed only of an alcohol or a mixed solvent of an alcohol and other solvents. In the case of the mixed solvent, the proportion of the alcohol is, for example, preferably 80% by mass or more, and more preferably 85% by mass or more.

Examples of the alcohol configuring the alcohol-containing solvent include lower alcohols such as methanol, ethanol, 1-propanol, isopropanol, 1-butanol (n-butyl alcohol), 2-methyl-1-propanol (isobutyl alcohol), 2-butanol (sec-butyl alcohol), and 2-methyl-2-propanol (tert-butyl alcohol). Among these, from the viewpoint of low reactivity with tetraalkoxysilane and silica, dispersion stability of silica particles, high removability in a drying step, and the like, for example, at least one alcohol selected from the group consisting of methanol, ethanol, 1-propanol, 2-propanol, and 2-methyl-2-propanol is preferable.

Examples of solvents other than the alcohol configuring the alcohol-containing solvent include water; ketones such as acetone, methyl ethyl ketone, and methyl isobutyl ketone; cellosolves such as methyl cellosolve, ethyl cellosolve, butyl cellosolve, and cellosolve acetate; ethers such as dioxane and tetrahydrofuran; and the like.

The alkali catalyst is a catalyst for accelerating the reaction of tetraalkoxysilane (a hydrolysis reaction and a condensation reaction). Examples thereof include basic catalysts such as ammonia, urea, and monoamine. Among these, for example, ammonia is particularly preferable.

An example of the alkali catalyst solution preparation step includes mixing an alcohol with aqueous ammonia. According to the present embodiment, an alkali catalyst solution composed of a mixed solvent of an alcohol and water and ammonia dissolved in the mixed solvent is obtained. As the alcohol, for example, a lower alcohol is preferable, and at least one alcohol selected from the group consisting of methanol, ethanol, 1-propanol, 2-propanol, and 2-methyl-2-propanol is more preferable. The proportion of the alcohol in the mixed solvent of the alcohol and water is, for example, preferably 80% by mass or more, and more preferably 85% by mass or more.

The concentration of the alkali catalyst in the alkali catalyst solution is, for example, preferably 0.5 mol/L or more and 1.5 mol/L or less, more preferably 0.6 mol/L or more and 1.2 mol/L or less, and even more preferably 0.65 mol/L or more and 1.1 mol/L or less.

The silica base particle generation step is a step of supplying tetraalkoxysilane and an alkali catalyst to the alkali catalyst solution and reacting the tetraalkoxysilane (a hydrolysis reaction and condensation reaction) in the alkali catalyst solution to generate silica base particles.

In the silica base particle generation step, core particles are generated by the reaction of the tetraalkoxysilane at the early stage of supplying tetraalkoxysilane (core particle generation stage), and then silica base particles are generated through the growth of the core particles (core particle growth stage).

Examples of the tetraalkoxysilane include tetramethoxysilane, tetraethoxysilane, tetrapropoxysilane, tetrabutoxysilane, and the like. From the viewpoint of controlling the reaction rate or uniformity of the shape of the silica base particles to be generated, for example, tetramethoxysilane or tetraethoxysilane is preferable.

The alkali catalyst supplied into the alkali catalyst solution may be a compound of the same type as or different type from the alkali catalyst contained in the alkali catalyst solution in advance. For example, it is preferable that the alkali catalysts be of the same type of compounds.

Examples of the alkali catalyst supplied to the alkali catalyst solution include basic catalysts such as ammonia, urea, and monoamine. Among these, for example, ammonia is particularly preferable. For example, aqueous ammonia is preferably added dropwise such that ammonia is supplied into the alkali catalyst solution.

The method for supplying the tetraalkoxysilane and the alkali catalyst to the alkali catalyst solution may be a continuous supply method or an intermittent supply method.

In the silica base particle generation step, the temperature of the alkali catalyst solution (temperature at the time of supply) is, for example, preferably 5° C. or higher and 50° C. or lower, and more preferably 15° C. or higher and 45° C. or lower.

Coating Step

The coating step is a step of forming a coating structure (for example, preferably a pore structure) consisting of a reaction product of a trifunctional silane compound on at least a part of the surface of the silica base particles (for example, preferably on the entire surface of the silica base particles).

In a case where a non-functional group of the trifunctional silane compound used in the coating step is a hydrophobic group such as an alkyl group, the coating structure (for example, preferably a pore structure) is formed by the coating step, and the surface of the silica particles is made hydrophobic.

In the coating step, for example, a trifunctional silane compound is added to the silica base particle suspension such that the trifunctional silane compound has a reaction within the surface of the silica base particles, and in this way, a coating structure (for example, a pore structure) consisting of the reaction product of the trifunctional silane compound is formed.

For example, the reaction of the trifunctional silane compound is performed by adding a trifunctional silane compound to the silica base particle suspension, and then heating the suspension with stirring. Specifically, for example, the suspension is heated to a temperature of 40° C. or higher and 70° C. or lower, a trifunctional silane compound is added to the suspension with stirring, and stirring is continued. The stirring is continued, for example, preferably for 10 minutes or more and 24 hours or less, more preferably for 60 minutes or more and 420 minutes or less, and even more preferably 80 minutes or more and 300 minutes or less.

Attaching Step

The attaching step is a step of attaching a molybdenum nitrogen-containing compound to the coating structure of the silica particles having the coating structure consisting of the reaction product of the trifunctional silane compound. The attaching step is, for example, preferably a step of attaching a molybdenum nitrogen-containing compound to the inside of pores of the pore structure consisting of the reaction product of the trifunctional silane compound.

For example, in order that the abundance ratio of the molybdenum lump in the silica particles (S) is 5% or less, the attaching step preferably has the following form.

That is, the attaching step is, for example, preferably a step of attaching a molybdenum nitrogen-containing compound to the coating structure consisting of a reaction product of a trifunctional silane compound in a reaction solution that contains water, an alcohol, silica particles having a coating structure consisting of a reaction product of a trifunctional silane compound, a molybdenum nitrogen-containing compound, and at least one compound selected from the group consisting of ammonia and an amine, in which the total amount of ammonia and an amine is 0.2% by mass or more and 4.5% by mass or less in the reaction solution.

In the present disclosure, the total amount of ammonia and an amine contained in the reaction solution is called “alkali concentration”. The alkali concentration of the reaction solution is the total mass (% by mass) of ammonia and an amine with respect to the total mass of the reaction solution.

From the viewpoint of increasing the solubility of the molybdenum nitrogen-containing compound (particularly, the compound with CAS Registry Number 117342-25-3), the alkali concentration of the reaction solution is, for example, preferably 0.2% by mass or more, more preferably 0.5% by mass or more, and even more preferably 1.0% by mass or more.

From the viewpoint of dispersion stability of the silica particles in the reaction solution, the alkali concentration of the reaction solution is, for example, preferably 4.5% by mass or less, more preferably 4.3% by mass or less, and even more preferably 4.0% by mass or less.

From the viewpoint of increasing the solubility of the molybdenum nitrogen-containing compound (particularly, the compound with CAS Registry Number 117342-25-3), at least one compound selected from the group consisting of ammonia and an amine contained in the reaction solution is, for example, preferably at least one compound selected from the group consisting of ammonia, dimethylamine, and diethylamine. That is, the reaction solution preferably contains, for example, at least one compound selected from the group consisting of ammonia, dimethylamine, and diethylamine.

From the viewpoint of increasing the solubility of the molybdenum nitrogen-containing compound, the total amount of ammonia, dimethylamine, and diethylamine contained in the reaction solution is, for example, preferably 0.2% by mass or more, more preferably 0.5% by mass or more, and even more preferably 1.0% by mass or more.

From the viewpoint of increasing the dispersion stability of the silica particles in the reaction solution, the total amount of ammonia, dimethylamine, and diethylamine contained in the reaction solution is, for example, preferably 4.5% by mass or less, more preferably 4.3% by mass or less, and even more preferably 4.0% by mass or less.

From the viewpoint of increasing the solubility of the molybdenum nitrogen-containing compound (particularly, the compound with CAS Registry Number 117342-25-3), at least one compound selected from the group consisting of ammonia and an amine contained in the reaction solution is, for example, particularly preferably ammonia. That is, it is particularly preferable that the reaction solution contain, for example, ammonia.

From the viewpoint of increasing the solubility of the molybdenum nitrogen-containing compound, the total amount of ammonia contained in the reaction solution is, for example, preferably 0.2% by mass or more, more preferably 0.5% by mass or more, and even more preferably 1.0% by mass or more.

From the viewpoint of dispersion stability of the silica particles in the reaction solution, the amount of ammonia contained in the reaction solution is, for example, preferably 4.5% by mass or less, more preferably 4.3% by mass or less, and even more preferably 4.0% by mass or less.

The amount of the molybdenum nitrogen-containing compound contained in the reaction solution with respect to 100 parts by mass of the silica particles having the coating structure consisting of the reaction product of the trifunctional silane compound is, for example, preferably 1 part by mass or more and 5 parts by mass or less, more preferably 1.2 parts by mass or more and 4.8 parts by mass or less, and even more preferably 1.5 parts by mass or more and 4.5 parts by mass or less.

Examples of the alcohol configuring the reaction solution include lower alcohols such as methanol, ethanol, 1-propanol, isopropanol, 1-butanol (n-butyl alcohol), 2-methyl-1-propanol (isobutyl alcohol), 2-butanol (sec-butyl alcohol), and 2-methyl-2-propanol (tert-butyl alcohol). Among these, from the viewpoint of low reactivity with tetraalkoxysilane and silica, dispersion stability of silica particles, high removability in a drying step, and the like, for example, at least one alcohol selected from the group consisting of methanol, ethanol, 1-propanol, 2-propanol, and 2-methyl-2-propanol is preferable.

From the viewpoint of dispersion stability of the silica particles, the amount of the alcohol contained in the reaction solution with respect to the total amount of the reaction solution is, for example, preferably 45% by mass or more and 95% by mass or less, more preferably 46% by mass or more and 94% by mass or less, and even more preferably 48% by mass or more and 92% by mass or less.

It is preferable that the attaching step include, for example, a reaction solution preparation step of preparing a reaction solution and a stirring step of stirring the reaction solution while keeping the temperature of the reaction solution in a desired range.

The reaction solution preparation step is performed, for example, by adding a molybdenum nitrogen-containing compound to the silica particle suspension (hereinafter, simply called “suspension” in the description of the reaction solution preparation step) obtained after the reaction between the silica base particles and a trifunctional silane compound. The reaction solution contains water brought in from the suspension, an alcohol, silica particles having a coating structure consisting of a reaction product of a trifunctional silane compound, and an alkali catalyst.

The reaction solution preparation step may include adding at least one compound selected from the group consisting of ammonia and an amine to the suspension, for the purpose of adjusting the alkali concentration of the reaction solution to 0.2% by mass or more and 4.5% by mass or less.

The reaction solution preparation step may include adding an alcohol and/or water to the suspension, for the purpose of adjusting the alkali concentration of the reaction solution to 0.2% by mass or more and 4.5% by mass or less.

There are no restrictions on the method and order of mixing together components in the reaction solution preparation step.

In an example of the exemplary embodiment, a molybdenum nitrogen-containing compound is added to the suspension, and at least one compound selected from the group consisting of ammonia and an amine is then further added to the suspension, such that the alkali concentration of the reaction solution is adjusted to 0.2% by mass or more and 4.5% by mass or less.

In another example of the exemplary embodiment, at least one compound selected from the group consisting of ammonia and an amine is added to the suspension, and then a molybdenum nitrogen-containing compound is added to the suspension to obtain a reaction solution having an alkali concentration of 0.2% by mass or more and 4.5% by mass or less.

In the reaction solution preparation step, a molybdenum nitrogen-containing compound is added to the suspension, for example, by the following (1) and/or (2).

(1) A molybdenum nitrogen-containing compound is directly added to the suspension.

(2) An alcohol solution containing a molybdenum nitrogen-containing compound is prepared in advance, and the alcohol solution is added to the suspension. The alcohol of the alcohol solution may be of the same type as or different type from the alcohol contained in the suspension. For example, it is preferable that the alcohols be of the same type. In the alcohol solution, the concentration of the molybdenum nitrogen-containing compound is, for example, preferably 0.05% by mass or more and 10% by mass or less, and more preferably 0.1% by mass or more and 6% by mass or less.

The stirring step is preferably a step of stirring the reaction solution for 1 hour or more while keeping the temperature of the reaction solution in a range of 25° C. or higher and 65° C. or lower. The temperature of the reaction solution is, for example, more preferably in a range of 30° C. or higher and 65° C. or lower, and even more preferably in a range of 35° C. or higher and 65° C. or lower. The stirring is continued, for example, preferably for 1 hour or more and 24 hours or less, more preferably for 1.5 hours or more and 12 hours or less, and even more preferably 2 hours or more and 6 hours or less. While stirring is being continued, the temperature of the reaction solution may be constant or change in the above temperature range.

Hydrophobic Treatment Step

The present manufacturing method may additionally have a hydrophobic treatment step of performing a hydrophobic treatment on the silica particles having the coating structure consisting of the reaction product of the trifunctional silane compound, after or during the attaching step. The hydrophobic treatment step is a step of additionally attaching a hydrophobic structure consisting of a hydrophobic agent to the coating structure consisting of the reaction product of the trifunctional silane compound. The hydrophobic treatment step is performed, for example, in a case where a non-functional group of the trifunctional silane compound used in the coating step is a hydrophilic group or in a case where the degree of hydrophobicity of the silica particles (S) is to be increased.

As the hydrophobic agent, a compound other than the trifunctional silane compound is used. Examples of the hydrophobic agent include a silazane compounds such as hexamethyldisilazane or tetramethyldisilazane, a titanate-based coupling agent, and an aluminum-based coupling agent.

The hydrophobic treatment step is performed, for example, by adding a molybdenum nitrogen-containing compound to the silica particle suspension obtained after the reaction between the silica base particles and the trifunctional silane compound, and further adding a hydrophobic agent. In a case where the hydrophobic agent is used, for example, it is preferable to heat the suspension to a temperature of 40° C. or higher and 70° C. or lower and to stir the suspension. The stirring is continued, for example, preferably for 10 minutes or more and 24 hours or less, more preferably for 20 minutes or more and 120 minutes or less, and even more preferably 20 minutes or more and 90 minutes or less.

Drying Step

A drying step of removing water and an alcohol from the silica particle suspension is performed after the attaching step or the hydrophobic treatment step is performed or while the attaching step or the hydrophobic treatment step is being performed. Examples of the drying method include heat drying, spray drying, and supercritical drying.

Spray drying can be performed by a conventionally known method using a spray dryer (such as a rotary disk spray dryer or a nozzle spray dryer). For example, in a hot air stream, the silica particle suspension is sprayed at a rate of 0.2 L/hour or more and 1 L/hour or less. The temperature of hot air is set such that, for example, the inlet temperature of the spray dryer is preferably in a range of 70° C. or higher and 400° C. or lower and the outlet temperature of the spray dryer is preferably in a range of 40° C. or higher and 120° C. or lower. The inlet temperature is, for example, more preferably in a range of 100° C. or higher and 300° C. or lower. The silica particle concentration in the silica particle suspension is, for example, preferably 10% by mass or more and 30% by mass or less.

Examples of the substance used as the supercritical fluid for supercritical drying include carbon dioxide, water, methanol, ethanol, acetone, and the like. From the viewpoint of treatment efficiency and from the viewpoint of suppressing the occurrence of coarse particles, the supercritical fluid is, for example, preferably supercritical carbon dioxide. Specifically, a step of using supercritical carbon dioxide is performed, for example, by the following operation.

The silica particle suspension is put in an airtight reactor, and then liquefied carbon dioxide is introduced into the reactor. Thereafter, the airtight reactor is heated, and the internal pressure of the airtight reactor is raised using a high-pressure pump such that the carbon dioxide in the airtight reactor is in a supercritical state. Then, the liquefied carbon dioxide is caused to flow into the airtight reactor, and the supercritical carbon dioxide is discharged from the airtight reactor, such that the supercritical carbon dioxide circulates in the silica particle suspension in the airtight reactor. While the supercritical carbon dioxide is circulating in the silica particle suspension, water and the alcohol dissolve in the supercritical carbon dioxide and are removed along with the supercritical carbon dioxide discharged from the airtight reactor. The internal temperature and pressure of the airtight reactor are set such that the carbon dioxide is in a supercritical state. Because the critical point of carbon dioxide is 31.1° C./7.38 MPa, for example, the temperature is set to 40° C. or higher and 200° C. or lower, and the pressure is set to 10 MPa or higher and 30 MPa or lower. The flow rate of the supercritical fluid in the airtight reactor is, for example, preferably 80 mL/sec or more and 240 mL/sec or less.

It is preferable that the silica particles having undergone the drying step, for example, be disintegrated or sieved such that coarse particles and aggregated particles are removed. The silica particles are disintegrated, for example, by a dry pulverizer such as a jet mill, a vibration mill, a ball mill, or a pin mill. The silica particles are sieved, for example, by a vibration sieve, a pneumatic sieving machine, or the like.

Electrostatic Charge Image Developing Toner

The toner according to the present exemplary embodiment includes toner particles and the silica particles (S) added to the exterior of the toner particles.

Toner Particles

The toner particles are composed, for example, of a binder resin and, as necessary, a colorant, a release agent, and other additives.

Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

Each of these binder resins may be used alone, or two or more of these binder resins may be used in combination.

As the binder resin, for example, a polyester resin is preferable.

Examples of the polyester resin include known polyester resins.

Examples of the polyester resin include a polycondensate of a polyvalent carboxylic acid and a polyhydric alcohol. As the polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these, lower alkyl esters (for example, having 1 or more and 5 or less carbon atoms) of these, and the like.

One polyvalent carboxylic acid may be used alone, or two or more polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among these, for example, aromatic diols and alicyclic diols are preferable as the polyhydric alcohol, and aromatic diols are more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One polyhydric alcohol may be used alone, or two or more polyhydric alcohols may be used in combination.

The glass transition temperature (Tg) of the polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K7121-1987, “Testing methods for transition temperatures of plastics”.

The weight-average molecular weight (Mw) of the polyester resin is, for example, preferably 5,000 or more and 1,000,000 or less, and more preferably 7,000 or more and 500,000 or less.

The number-average molecular weight (Mn) of the polyester resin is, for example, preferably 2,000 or more and 100,000 or less.

The molecular weight distribution Mw/Mn of the polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC·HLC-8120GPC manufactured by Tosoh Corporation as a measurement device, TSKgel Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

The polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is being distilled off. In a case where a monomer with poor compatibility takes part in the reaction, for example, the monomer with poor compatibility may be condensed in advance with an acid or an alcohol that is to be polycondensed with the monomer, and then polycondensed with the major component.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

Colorant

Examples of colorants include pigments such as carbon black, chrome yellow, Hansa yellow, benzidine yellow, threne yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye, and inorganic pigments such as a titanium compound and silica.

One colorant may be used alone, or two or more colorants may be used in combination.

The colorant is not limited to a substance having absorption in the visible light region. The colorant may be, for example, a substance having absorption in a near-infrared region or a fluorescent colorant.

Examples of the colorant having absorption in the near-infrared region include an aminium salt-based compound, a naphthalocyanine-based compound, a squarylium-based compound, a croconium-based compound, and the like.

Examples of the fluorescent colorant include the fluorescent colorants described in paragraph “0027” of JP2021-127431A.

The colorant may be a luminous colorant. Examples of the luminous colorant include metal powder such as aluminum, brass, bronze, nickel, stainless steel, or zinc; mica coated with titanium oxide or yellow iron oxide; a coated flaky inorganic crystal substrate such as barium sulfate, layered silicate, or silicate of layered aluminum; monocrystal plate-shaped titanium oxide, basic carbonate, bismuth oxychloride, natural guanine, flaky glass powder, metal-deposited flaky glass powder; and the like.

One colorant may be used alone, or two or more colorants may be used in combination.

As the colorant, a colorant having undergone a surface treatment as necessary may be used, or a dispersant may be used in combination with the colorant.

In the present exemplary embodiment, the toner particles may or may not contain a colorant. The toner according to the present exemplary embodiment may be a so-called transparent toner which is a toner having toner particles that do not contain a colorant.

In a case where the toner particles of the present exemplary embodiment contain a colorant, the content of the colorant with respect to the total amount of the toner particles is, for example, preferably 1% by mass or more and 30% by mass or less, and more preferably 3% by mass or more and 15% by mass or less.

Release Agent

Examples of the release agent include hydrocarbon-based wax; natural wax such as carnauba wax, rice wax, and candelilla wax; synthetic or mineral petroleum-based wax such as montan wax; ester-based wax such as fatty acid esters and montanic acid esters; and the like. The release agent is not limited to these.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total mass of the toner particles is, for example, preferably 1% by mass or more and 20% by mass or less, and more preferably 5% by mass or more and 15% by mass or less.

Other Additives

Examples of other additives include known additives such as a magnetic material, a charge control agent, and inorganic powder. These additives are incorporated into the toner particles as internal additives.

Characteristics of Toner Particles and the Like

The toner particles may be toner particles that have a single-layer structure or toner particles having a so-called core/shell structure that is configured with a core portion (core particle) and a coating layer (shell layer) covering the core portion.

The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter Inc.) and using ISOTON-II (manufactured by Beckman Coulter Inc.) as an electrolytic solution.

For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER IULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-based particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-based particle size D84v and a number-based particle size D84p.

By using these, a volume-average particle size distribution index (GSDv) is calculated as (D84v/D16v)^{1/2}, and a number-average particle size distribution index (GSDp) is calculated as (D84p/D16p)^{1/2}.

The average circularity of the toner particles is, for example, preferably 0.94 or more and 1.00 or less, and more preferably 0.95 or more and 0.98 or less.

The average circularity of the toner particles is determined by (circular equivalent perimeter)/(perimeter) [(perimeter of circle having the same projected area as particle image)/(perimeter of projected particle image)]. Specifically, the average circularity is a value measured by the following method.

First, toner particles as a measurement target are collected by suction, and a flat flow of the particles is formed. Then, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains external additives, the toner (developer) as a measurement target is dispersed in water containing a surfactant, then the dispersion is treated with ultrasonic waves such that the external additives are removed, and the toner particles are collected.

External Additive

The toner according to the present exemplary embodiment contains the silica particles (S) as an external additive. The amount of the silica particles (S) added to the exterior of the toner particles with respect to 100 parts by mass of the toner particles is, for example, preferably 0.1 parts by mass or more and 3.0 parts by mass or less, more preferably 0.2 parts by mass or more and 2.0 parts by mass or less, and even more preferably 0.3 parts by mass or more and 1.5 parts by mass or less.

The toner according to the present exemplary embodiment may contain, as an external additive, silica particles other than the silica particles (S). As such silica particles, for example, hydrophobic silica particles are preferable which are obtained by treating the surface of silica particles, such as sol-gel silica, aqueous colloidal silica, alcoholic silica, fumed silica, and molten silica, with a hydrophobic agent (for example, a silane-based coupling agent, a silicone oil, a titanate-based coupling agent, an aluminum-based coupling agent, or a silazane compound).

In a case where the toner according to the present exemplary embodiment contains silica particles other than the silica particles (S), the amount of such silica particles added to the exterior of the toner particles with respect to 100 parts by mass of the toner particles is, for example, preferably 0.1 parts by mass or more and 3.0 parts by mass or less, more preferably 0.2 parts by mass or more and 2.0 parts by mass or less, and even more preferably 0.3 parts by mass or more and 1.5 parts by mass or less.

The toner according to the present exemplary embodiment may contain an external additive other than silica particles. Examples of the external additive other than silica particles include inorganic particles such as TiO₂, Al₂O₃, CuO, ZnO, SnO₂, CeO₂, Fe₂O₃, MgO, BaO, CaO, K₂O, Na₂O, ZrO₂, CaO SiO₂, Al₂O₃·2SiO₂, CaCO₃, MgCO₃, BaSO₄, and MgSO₄; hydrophobic inorganic particles obtained by treating the surface of the above inorganic particles with a hydrophobic agent (for example, a silane-based coupling agent, a silicone oil, a titanate-based coupling agent, an aluminum-based coupling agent, or a silazane compound); resin particles such as polystyrene, polymethyl methacrylate, and a melamine resin; a cleaning activator such as a fluorine-based high-molecular-weight substance; and the like.

Manufacturing Method of Toner

The toner according to the present exemplary embodiment is obtained by manufacturing toner particles and then adding external additives to the exterior of the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). There are no particular restrictions on these manufacturing methods, and known manufacturing methods are adopted. Among the above methods, for example, the aggregation and coalescence method may be used for obtaining toner particles.

Specifically, for example, in a case where the toner particles are manufactured by the aggregation and coalescence method,
the toner particles are manufactured through a step of preparing a resin particle dispersion in which resin particles to be a binder resin are dispersed (a resin particle dispersion-preparing step), a step of allowing the resin particles (plus other particles as necessary) to be aggregated in the resin particle dispersion (having been mixed with another particle dispersion as necessary) to form aggregated particles (aggregated particle-forming step), and a step of heating an aggregated particle dispersion in which the aggregated particles are dispersed to allow the aggregated particles to undergo coalescence and to form toner particles (coalescence step).

Hereinafter, each of the steps will be specifically described.

In the following section, a method for obtaining toner particles containing a colorant and a release agent will be described. The colorant and the release agent are used as necessary. It goes without saying that other additives different from the colorant and the release agent may also be used.

Resin Particle Dispersion-Preparing Step

For example, a colorant particle dispersion in which colorant particles are dispersed and a release agent particle dispersion in which release agent particles are dispersed are prepared together with the resin particle dispersion in which resin particles to be a binder resin are dispersed.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. Each of these media may be used alone, or two or more of these media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, for example, an anionic surfactant and a cationic surfactant are particularly preferable. The nonionic surfactant may be used in combination with an anionic surfactant or a cationic surfactant.

One surfactant may be used alone, or two or more surfactants may be used in combination.

As for the resin particle dispersion, examples of the method for dispersing resin particles in the dispersion medium include general dispersion methods such as a rotary shearing homogenizer, a ball mill having media, a sand mill, and a dyno mill. Depending on the type of resin particles, the resin particles may be dispersed in the dispersion medium by using a transitional phase inversion emulsification method. The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes phase transition from W/O to O/W and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and even more preferably 0.1 μm or more and 0.6 μm or less.

For determining the volume-average particle size of the resin particles, a particle size distribution is measured using a laser diffraction-type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant particle dispersion and a release agent particle dispersion are prepared in the same manner as that adopted for preparing the resin particle dispersion. That is, the volume-average particle size of particles, the dispersion medium, the dispersion method, and the particle content in the resin particle dispersion are also applied to the colorant particles to be dispersed in the colorant particle dispersion and the release agent particles to be dispersed in the release agent particle dispersion.

Aggregated Particle-Forming Step

Next, the resin particle dispersion is mixed with the colorant particle dispersion and the release agent particle dispersion.

Then, in the mixed dispersion, the resin particles, the colorant particles, and the release agent particles are hetero-aggregated such that aggregated particles are formed which have a diameter close to the diameter of the target toner particles and include the resin particles, the colorant particles, and the release agent particles.

Specifically, for example, an aggregating agent is added to the mixed dispersion, the pH of the mixed dispersion is adjusted such that the dispersion is acidic (for example, pH of 2 or higher and 5 or lower), and a dispersion stabilizer is added thereto as necessary. Then, the dispersion is heated to a temperature close to the glass transition temperature of the resin particles (specifically, for example, to a temperature equal to or higher than the glass transition temperature of the resin particles −30° C. and equal to or lower than the glass transition temperature of the resin particles −10° C.) such that the particles dispersed in the mixed dispersion are aggregated, thereby forming aggregated particles. In the aggregated particle-forming step, for example, in a state where the mixed dispersion is being stirred with a rotary shearing homogenizer, an aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant contained in the mixed dispersion, an inorganic metal salt, and a metal complex having a valency of 2 or higher. In a case where a metal complex is used as the aggregating agent, the amount of the surfactant used is reduced, and the charging characteristics are improved.

In addition to the aggregating agent, an additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; inorganic metal salt polymers such as polyaluminum chloride, polyaluminum hydroxide, and calcium polysulfide; and the like.

As the chelating agent, a water-soluble chelating agent may also be used. Examples of the chelating agent include oxycarboxylic acids such as tartaric acid, citric acid, and gluconic acid; aminocarboxylic acids such as iminodiacetic acid (IDA), nitrilotriacetic acid (NTA), and ethylenediaminetetraacetic acid (EDTA); and the like.

The amount of the chelating agent added with respect to 100 parts by mass of resin particles is, for example, preferably 0.01 parts by mass or more and 5.0 parts by mass or less, and more preferably 0.1 parts by mass or more and less than 3.0 parts by mass.

Coalescence Step

The aggregated particle dispersion in which the aggregated particles are dispersed is then heated to, for example, a temperature equal to or higher than the glass transition temperature of the resin particles (for example, a temperature higher than the glass transition temperature of the resin particles by 10° C. to 30° C.) such that the aggregated particles coalesce, thereby forming toner particles.

Toner particles are obtained through the above steps.

The toner particles may be manufactured through a step of obtaining an aggregated particle dispersion in which the aggregated particles are dispersed, then mixing the aggregated particle dispersion with a resin particle dispersion in which resin particles are dispersed to cause the resin particles to be aggregated and adhere to the surface of the aggregated particles and to form second aggregated particles, and a step of heating a second aggregated particle dispersion in which the second aggregated particles are dispersed to cause the second aggregated particles to coalesce and to form toner particles having a core/shell structure.

After the coalescence step ends, the toner particles in the dispersion are subjected to known washing step, solid-liquid separation step, and drying step, thereby obtaining dry toner particles. As the washing step, from the viewpoint of charging properties, for example, displacement washing may be thoroughly performed using deionized water. As the solid-liquid separation step, from the viewpoint of productivity, for example, suction filtration, pressure filtration, or the like may be performed. As the drying step, from the viewpoint of productivity, for example, freeze-drying, flush drying, fluidized drying, vibratory fluidized drying, or the like may be performed.

Then, for example, by adding an external additive to the obtained dry toner particles and mixing together the external additive and the toner particles, the toner according to the present exemplary embodiment is manufactured. The mixing may be performed, for example, using a V blender, a Henschel mixer, a Lodige mixer, or the like. As necessary, coarse particles of the toner may be removed using a vibratory sieving machine, a pneumatic sieving machine, or the like.

Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer which contains only the toner according to the present exemplary embodiment or a two-component developer which is obtained by mixing together the toner and a carrier.

The carrier is not particularly limited, and examples thereof include known carriers. Examples of the carrier include a coated carrier obtained by coating the surface of a core material consisting of magnetic powder with a resin; a magnetic powder dispersion-type carrier obtained by dispersing and mixing magnetic powder in a matrix resin and; a resin impregnation-type carrier obtained by impregnating porous magnetic powder with a resin; and the like.

Each of the magnetic powder dispersion-type carrier and the resin impregnation-type carrier may be a carrier obtained by coating the surface of a core material, which is particles configuring the carrier, with a resin.

Examples of the magnetic powder include magnetic metals such as iron, nickel, and cobalt; magnetic oxides such as ferrite and magnetite; and the like.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin configured with an organosiloxane bond, a product obtained by modifying the straight silicone resin, a fluororesin, polyester, polycarbonate, a phenol resin, an epoxy resin, and the like. The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specifically, examples of the resin coating method include an immersion method of immersing the core material in the solution for forming a coating layer; a spray method of spraying the solution for forming a coating layer to the surface of the core material; a fluidized bed method of spraying the solution for forming a coating layer to the core material that is floating by an air flow; a kneader coater method of mixing the core material of the carrier with the solution for forming a coating layer in a kneader coater and then removing solvents; and the like.

The mixing ratio (mass ratio) between the toner and the carrier, represented by toner:carrier, in the two-component developer is, for example, preferably 1:100 to 30:100, and more preferably 3:100 to 20:100.

Image Forming Apparatus and Image Forming Method

The image forming apparatus and image forming method according to the present exemplary embodiment will be described.

The image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image by using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed which has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralizing unit that neutralizes charge by irradiating the surface of the image holder with charge neutralizing light before charging after the transfer of the toner image.

In a case where the image forming apparatus according to the present exemplary embodiment is the intermediate transfer-type apparatus, as the transfer unit, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present exemplary embodiment, for example, a portion including the developing unit may be a cartridge structure (process cartridge) detachable from the image forming apparatus. As the process cartridge, for example, a process cartridge is suitably used which includes a developing unit that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

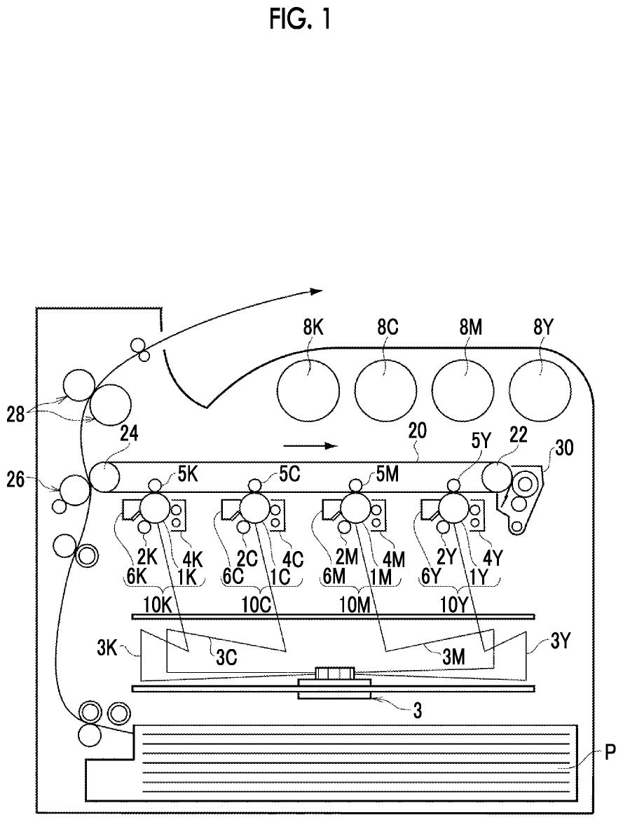

FIG. 1 is a view schematically showing the configuration of the image forming apparatus according to the present exemplary embodiment.

The image forming apparatus shown in FIG. 1 includes first to fourth image forming units 10Y, 10M, 10C, and 10K (image forming means) adopting an electrophotographic method that prints out images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are detachable from the image forming apparatus.

An intermediate transfer belt (an example of an intermediate transfer member) 20 passing through the units 10Y, 10M, 10C, and 10K extends above the units. The intermediate transfer belt 20 is looped around a driving roll 22 and a support roll 24, and runs toward a fourth unit 10K from a first unit 10Y Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the side of the image holding surface of the intermediate transfer belt 20.

Toners of yellow, magenta, cyan, and black, stored in containers of toner cartridges 8Y, 8M, 8C, and 8K are supplied to developing devices (an example of developing units) 4Y, 4M, 4C, and 4K of units 10Y, 10M, 10C, and 10K, respectively.

The first to fourth units 10Y, 10M, 10C, and 10K have the same configuration and perform the same operation. Therefore, in the present specification, as a representative, the first unit 10Y will be described which is placed on the upstream side of the running direction of the intermediate transfer belt and forms a yellow image.

The first unit 10Y has a photoreceptor 1Y that acts as an image holder. Around the photoreceptor 1Y, a charging roll 2Y (an example of charging unit) that charges the surface of the photoreceptor 1Y at a predetermined potential, an exposure device 3 (an example of electrostatic charge image forming unit) that exposes the charged surface to a laser beam 3Y based on color-separated image signals to form an electrostatic charge image, a developing device 4Y (an example of developing unit) that develops the electrostatic charge image by supplying a charged toner to the electrostatic charge image, a primary transfer roll 5Y (an example of primary transfer unit) that transfers the developed toner image onto the intermediate transfer belt 20, and a photoreceptor cleaning device 6Y (an example of cleaning unit) that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y A bias power supply (not shown in the drawing) for applying a primary transfer bias is connected to primary transfer rolls 5Y, 5M, 5C, and 5K of each unit. Each bias power supply changes the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with a laser beam, the specific resistance of the portion irradiated with the laser beam changes. Therefore, from an exposure device 3, the laser beam 3Y is radiated to the surface of the charged photoreceptor 1Y according to the image data for yellow transmitted from the control unit not shown in the drawing. As a result, an electrostatic charge image of the yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y is developed as a toner image by the developing device 4Y and visualized.

The developing device 4Y contains, for example, an electrostatic charge image developer that contains at least a yellow toner and a carrier. By being agitated in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. In the first unit 10Y, the transfer bias is set, for example, to +10 μA under the control of the control unit (not shown in the drawing).

The residual toner on the photoreceptor 1Y is removed by a photoreceptor cleaning device 6Y and collected.

The primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll 26 (an example of a secondary transfer unit) disposed on the side of the image holding surface of the intermediate transfer belt 20. Meanwhile, via a supply mechanism, recording paper P (an example of a recording medium) is fed at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, which makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer portion, and the voltage thereof is controlled.

Then, the recording paper P is transported into a pressure contact portion (nip portion) of a pair of fixing rolls in the fixing device 28 (an example of fixing unit), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet and the like, in addition to the recording paper P.

In order to further improve the smoothness of the image surface after fixing, for example, it is preferable that the surface of the recording paper P be also smooth. For instance, coated paper prepared by coating the surface of plain paper with a resin or the like, art paper for printing, and the like are suitably used.

The recording paper P on which the color image has been fixed is transported to an output portion, and a series of color image forming operations is finished.

Process Cartridge and Toner Cartridge

The process cartridge according to the present exemplary embodiment will be described.

The process cartridge according to the present exemplary embodiment includes a developing unit which contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing unit and, for example, at least one member selected from other units, such as an image holder, a charging unit, an electrostatic charge image forming unit, and a transfer unit, as necessary.

An example of the process cartridge according to the present exemplary embodiment will be shown below, but the present invention is not limited thereto. Hereinafter, among the parts shown in the drawing, main parts will be described, and others will not be described.

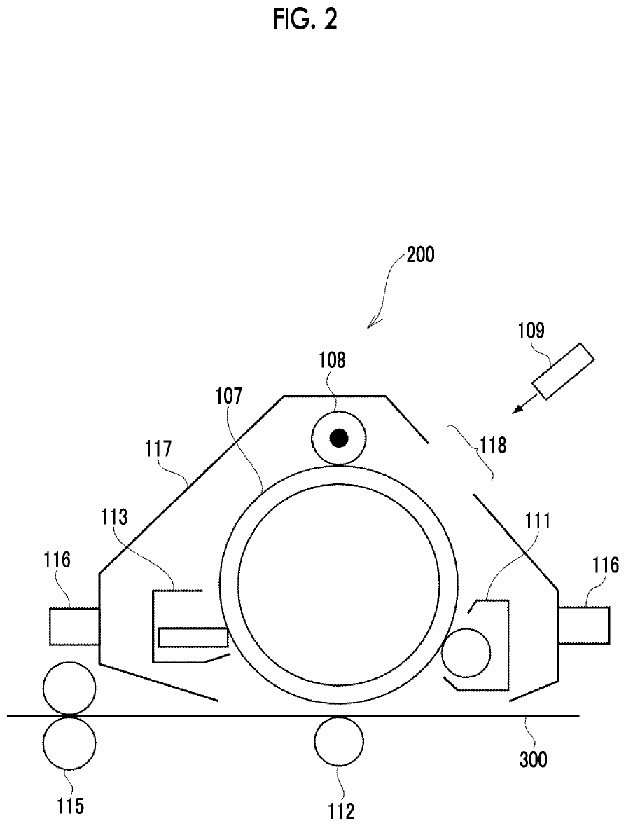

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of an image holder), a charging roll 108 (an example of a charging unit) that is provided on the periphery of the photoreceptor 107, a developing device 111 (an example of a developing unit), a photoreceptor cleaning device 113 (an example of a cleaning unit), which are integrally combined and held in the housing 117. The process cartridge 200 forms a cartridge in this way.

In FIG. 2, 109 represents an exposure device (an example of an electrostatic charge image forming unit), 112 represents a transfer device (an example of a transfer unit), 115 represents a fixing device (an example of a fixing unit), and 300 represents recording paper (an example of a recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing unit provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In a case where the amount of the toner contained in the container of the toner cartridge is low, the toner cartridge is replaced.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

Unless otherwise specified, synthesis, treatment, manufacturing, and the like are carried out at room temperature (25° C.±3° C.).

Manufacturing of Silica Particles

### Example 1

Granulating Step

Methanol and aqueous ammonia in the amounts and concentrations shown in Table 1 are put into a glass container equipped with a metal stirring rod, a dripping nozzle, and a thermometer, and stirred and mixed together, thereby preparing an alkali catalyst solution. The temperature of the alkali catalyst solution is adjusted to 25° C., and the alkali catalyst solution is subjected to nitrogen purging. Then, while the alkali catalyst solution is being stirred at a liquid temperature kept at 25° C., tetramethoxysilane (TMOS) and aqueous ammonia in the amounts and concentrations shown in Table 1 are simultaneously added dropwise to the solution, thereby obtaining a silica base particle suspension.

Coating Step

The liquid temperature of the silica base particle suspension is adjusted to 60° C., and methyltrimethoxysilane (MTMS) in the amount shown in Table 1 is added for 120 minutes to the suspension being stirred at a temperature kept at 60° C. such that MTMS reacts, thereby forming a coating structure consisting of a reaction product of MTMS on the surface of the silica base particles.

Attaching Step

The liquid temperature of the silica particle suspension after the reaction of between the silica base particles and MTMS is adjusted to the temperature shown in Table 1. In a state where the liquid temperature of the silica particle suspension is maintained, aqueous ammonia, an aqueous dimethylamine solution, or an aqueous diethylamine solution is added as necessary to the suspension being stirred, and TP-415 (Hodogaya Chemical Co., Ltd., CAS Registry Number 117342-25-3) is further added thereto, thereby obtaining a reaction solution of the attaching step. The composition of the reaction solution is shown in Table 2. In a state where the liquid temperature of the reaction is maintained, the reaction solution is stirred for 60 minutes.

Drying Step

The reaction solution is moved to a drying container. While the reaction solution is being stirred, liquefied carbon dioxide is injected into the drying container, the internal temperature and internal pressure of the drying container are raised to 150° C. and 15 MPa respectively, and the reaction solution is continuously stirred in a state where the temperature and pressure are kept and the supercritical state of the carbon dioxide is maintained. The carbon dioxide is flowed in and out at a flow rate of 5 L/min, and water and an alcohol are removed for 120 minutes, thereby obtaining silica particles.

Measurement of Characteristics of Silica Particles

By the measurement method described above, the average primary particle size, the particle size distribution index, the average circularity, N_{Mo}/N_{Si}, B/A, and the abundance ratio of molybdenum lumps relating to the silica particles are measured. The results are shown in Table 2.

Measurement of Charge Distribution

The silica particles (2 parts by mass) and 100 parts by mass of crosslinked acrylic resin particles (manufactured by NIPPON SHOKUBAI CO., LTD., MA1010) are mixed together, and 5 parts by mass of the mixture is mixed with 50 parts by mass of ferrite particles (manufactured by JFE Chemical Corporation, KNI-106GSM), thereby preparing a sample for measuring charge.

The sample is stirred for 5 minutes with a paint shaker (manufactured by TURBULA, TURBULA shaker/mixer) in a chamber at a temperature of 20° C. and a relative humidity of 50%, and evaluated by image analysis of charge spectrography (CSG).

Whether the charge distribution is wide or narrow is determined based on a value obtained by dividing the difference between a charge amount Q(20) accounting for an integrated cumulative percentage of 20% in the charge distribution and a charge amount Q(80) accounting for an integrated cumulative percentage of 80% in the charge distribution by a charge amount Q(50) accounting for an integrated cumulative percentage of 50% in the charge distribution, that is, a value of [Q(80)−Q(20)]/Q(50). The smaller the value, the narrower the charge distribution. The values are classified as follows. The results are shown in Table 2.

A: The value of [Q(80)−Q(20)]/Q(50) is 0.75 or less.

B: The value of [Q(80)−Q(20)]/Q(50) is more than 0.75 and 0.85 or less.

C: The value of [Q(80)−Q(20)]/Q(50) is more than 0.85 and 1.0 or less.

D: The value of [Q(80)−Q(20)]/Q(50) is more than 1.0.

Measurement of Change Rate of Charge Amount

The silica particles (2 parts by mass) and 100 parts by mass of crosslinked acrylic resin particles (manufactured by NIPPON SHOKUBAI CO., LTD., MA1010) are mixed together, and 5 parts by mass of the mixture is mixed with 50 parts by mass of ferrite particles (manufactured by JFE Chemical Corporation, KNI-106GSM), thereby preparing a sample for measuring charge amount.

The sample is left to stand under high temperature and high humidity (a temperature of 30° C. and a relative humidity of 90%) for 7 days. Before and after standing, the charge amount of the sample is measured using a blow-off charge amount measuring device (Toshiba Chemical Corporation, TB-200). The absolute value of a change rate of charge amount |(charge amount before standing−charge amount after standing)/charge amount before standing| is calculated and classified as follows. The results are shown in Table 2.

A: 0 or more and less than 0.2

B: 0.2 or more and less than 0.35

C: 0.35 or more and less than 0.5

D: 0.5 or more

### Examples 2 to 33 and Comparative Examples 1 to 3

Silica particles are manufactured in the same manner as in Example 1, except that the conditions of each step are changed as described in Table 1. The characteristics, charge distribution, and charge rate of charge amount of the silica particles are measured in the same manner as in Example 1. The results are shown in Table 2.

TABLE 1

| | Granulating step | | | | | | | Coating | Attaching step | | |
|---|---|---|---|---|---|---|---|---|---|---|---|
| | Preparation of alkali catalyst solution | | | | Dropwise addition | | | step | | Addition | TP- |
| | Alcohol | | Aqueous ammonia | | TMOS | Aqueous ammonia | | MTMS | | for | 415 |
| | | Parts | | Parts | Parts | | Parts | Parts | Liquid | composition | Parts |
| | | by | Concentration | by | by | Concentration | by | by | temperature | adjustment | by |
| | Type | mass | % by mass | mass | mass | % by mass | mass | mass | ° C. | Type | mass |
| Comparative | Methanol | 445 | 10.0 | 49 | 257 | 8.0 | 67 | 10 | 60 | Ammonia | 3.7 |
| Example 1 | | | | | | | | | | | |
| Example 1 | Methanol | 469 | 10.0 | 49 | 258 | 8.0 | 67 | 10 | 25 | Ammonia | 2.5 |
| Example 2 | Methanol | 469 | 10.0 | 49 | 258 | 8.0 | 67 | 10 | 25 | Ammonia | 3.8 |
| Example 3 | Methanol | 445 | 10.0 | 49 | 257 | 8.0 | 67 | 10 | 62 | Ammonia | 2.5 |
| Example 4 | Methanol | 445 | 10.0 | 49 | 257 | 8.0 | 67 | 10 | 60 | Ammonia | 3.7 |
| Example 5 | Methanol | 469 | 10.0 | 49 | 258 | 8.0 | 67 | 10 | 60 | Ammonia | 3.7 |
| Example 6 | Methanol | 445 | 10.0 | 49 | 257 | 8.0 | 67 | 10 | 62 | Ammonia | 5.0 |
| Example 7 | Methanol | 445 | 10.0 | 49 | 257 | 8.0 | 67 | 10 | 62 | Ammonia | 5.0 |
| Example 8 | Methanol | 445 | 10.0 | 49 | 257 | 8.0 | 67 | 10 | 60 | Ammonia | 3.7 |
| Example 9 | Methanol | 445 | 10.0 | 49 | 257 | 8.0 | 67 | 10 | 61 | Ammonia | 2.5 |
| Example 10 | Methanol | 445 | 10.0 | 49 | 257 | 8.0 | 67 | 10 | 60 | Ammonia | 4.0 |
| Example 11 | Methanol | 445 | 10.0 | 49 | 257 | 8.0 | 67 | 10 | 60 | Ammonia | 3.7 |
| Example 12 | Methanol | 445 | 10.0 | 49 | 257 | 8.0 | 67 | 10 | 60 | Ammonia | 3.8 |
| Comparative | Methanol | 445 | 10.0 | 49 | 257 | 8.0 | 67 | 10 | 62 | Ammonia | 3.7 |
| Example 2 | | | | | | | | | | | |
| Example 13 | Methanol | 950 | 9.1 | 110 | 450 | 8.0 | 30 | 100 | 52 | Ammonia | 3.7 |
| Example 14 | Methanol | 994 | 9.8 | 104 | 547 | 8.0 | 117 | 22 | 48 | Ammonia | 3.8 |
| Example 15 | Methanol | 994 | 9.8 | 104 | 547 | 8.0 | 117 | 3 | 38 | Ammonia | 3.7 |
| Example 16 | Methanol | 950 | 12.0 | 250 | 1100 | 8.0 | 222 | 50 | 60 | Ammonia | 4.0 |
| Example 17 | Methanol | 950 | 12.0 | 250 | 1100 | 8.0 | 330 | 50 | 60 | Ammonia | 3.3 |
| Example 18 | Methanol | 950 | 12.0 | 250 | 1100 | 8.0 | 330 | 50 | 60 | Ammonia | 3.7 |
| Example 19 | Methanol | 950 | 12.0 | 250 | 1100 | 8.0 | 410 | 50 | 40 | Ammonia | 3.7 |
| Example 20 | Methanol | 469 | 10.0 | 49 | 258 | 8.0 | 67 | 10 | 60 | Ammonia | 2.5 |
| Example 21 | Methanol | 950 | 9.6 | 166 | 1000 | 8.0 | 134 | 50 | 61 | Ammonia | 2.5 |
| Example 22 | Methanol | 469 | 10.0 | 49 | 258 | 8.0 | 67 | 10 | 60 | Ammonia | 1.2 |
| Example 23 | Methanol | 950 | 9.6 | 166 | 1000 | 8.0 | 134 | 50 | 61 | Ammonia | 7.0 |
| Example 24 | Methanol | 950 | 9.6 | 166 | 1000 | 8.0 | 134 | 50 | 60 | Ammonia | 10.0 |
| Example 25 | Methanol | 445 | 10.0 | 49 | 257 | 8.0 | 67 | 10 | 42 | Ammonia | 3.7 |
| Example 26 | Methanol | 445 | 10.0 | 49 | 257 | 8.0 | 67 | 10 | 42 | Ammonia | 4.0 |
| Example 27 | Methanol | 994 | 9.8 | 104 | 547 | 8.0 | 117 | 22 | 52 | Ammonia | 10.0 |
| Example 28 | Methanol | 445 | 10.0 | 49 | 257 | 8.0 | 67 | 10 | 42 | Ammonia | 5.0 |
| Comparative | Methanol | 469 | 10.0 | 49 | 258 | 8.0 | 67 | 10 | 60 | Ammonia | 3.7 |
| Example 3 | | | | | | | | | | | |
| Example 29 | Methanol | 445 | 10.0 | 49 | 257 | 8.0 | 67 | 10 | 60 | Dimethylamine | 2.5 |
| Example 30 | Ethanol | 445 | 10.0 | 49 | 257 | 8.0 | 67 | 10 | 61 | Diethylamine | 3.8 |
| Example 31 | 1-Propanol | 445 | 10.0 | 49 | 257 | 8.0 | 67 | 10 | 60 | Ammonia | 2.5 |
| Example 32 | 2-Propanol | 445 | 10.0 | 49 | 257 | 8.0 | 67 | 10 | 61 | Ammonia | 3.8 |
| Example 33 | 2-Methyl-2- | 445 | 10.0 | 49 | 257 | 8.0 | 67 | 10 | 62 | Ammonia | 3.8 |
| | propanol | | | | | | | | | | |

TABLE 2

| | Composition of reaction solution | | | | | | | | | | | | | |
|---|---|---|---|---|---|---|---|---|---|---|---|---|---|---|
| | | | Solid | | | | | | | | | | | |
| | | | content | | | | | | | | | | | |
| | | | (silica | | | Silica particles | | | | | | | | |
| | | | particles | | | | Particle | | | | | | | |
| | | | having | | Am- | Average | size | | | | | Abundance | | Change |
| | | | coating | TP- | monia + | primary | index | Average | | | | ratio of | Charge | rate of |
| | Water | Alcohol | structure) | 415 | amine | size | distribu- | circular- | N_{MO}/ | | | molybdenum | distribu- | charge |
| | % by | % by | % by | % by | % by | particle | tion | ity | Nₛᵢ | B/A | B | lumps | tion | amount |
| | mass | mass | mass | mass | mass | nm | — | — | — | — | cm³/g | % | — | — |
| Comparative | 9.17 | 59.1 | 30.0 | 1.11 | 0.1 | 56.1 | 1.18 | 0.903 | 0.29 | 3.50 | 1.10 | 11.2 | D | D |
| Example 1 | | | | | | | | | | | | | | |
| Example 1 | 3.1 | 93.0 | 3.8 | 0.1 | 0.2 | 62.5 | 1.10 | 0.870 | 0.21 | 4.00 | 1.20 | 4.5 | B | B |
| Example 2 | 1.7 | 91.5 | 6.5 | 0.3 | 0.5 | 66.7 | 1.10 | 0.900 | 0.33 | 3.80 | 0.95 | 0.8 | A | A |
| Example 3 | 5.8 | 63.1 | 29.4 | 0.7 | 1.2 | 56.1 | 1.18 | 0.903 | 0.22 | 3.80 | 0.94 | 0.6 | A | A |
| Example 4 | 7.99 | 59.1 | 30.0 | 1.11 | 1.8 | 56.1 | 1.18 | 0.903 | 0.32 | 3.80 | 1.00 | 1.6 | A | A |
| Example 5 | 6.0 | 49.7 | 41.0 | 1.5 | 2.4 | 64.3 | 1.10 | 0.881 | 0.32 | 3.40 | 1.04 | 1.2 | A | A |
| Example 6 | 12.6 | 55.4 | 28.2 | 1.41 | 2.4 | 56.1 | 1.18 | 0.903 | 0.44 | 4.10 | 1.10 | 0.6 | A | A |
| Example 7 | 9.6 | 56.2 | 30.0 | 1.5 | 2.7 | 56.1 | 1.18 | 0.903 | 0.43 | 4.10 | 1.00 | 0.9 | A | A |
| Example 8 | 7.99 | 56.1 | 30.0 | 1.11 | 2.8 | 56.1 | 1.18 | 0.903 | 0.31 | 3.90 | 1.00 | 1.2 | A | A |
| Example 9 | 10.5 | 56.4 | 29.4 | 0.7 | 3.2 | 56.1 | 1.18 | 0.903 | 0.22 | 3.60 | 0.94 | 0.5 | A | A |
| Example 10 | 12.4 | 56.6 | 26.4 | 1.1 | 3.9 | 56.1 | 1.18 | 0.903 | 0.35 | 3.80 | 0.94 | 0.8 | B | A |
| Example 11 | 7.79 | 57.1 | 30.0 | 1.11 | 4.0 | 56.1 | 1.18 | 0.903 | 0.33 | 3.80 | 1.10 | 1.1 | B | A |
| Example 12 | 3.0 | 51.1 | 40.0 | 1.5 | 4.5 | 56.0 | 1.20 | 0.900 | 0.35 | 4.80 | 0.80 | 3.9 | B | B |
| Comparative | 6.79 | 57.1 | 30.0 | 1.11 | 5.0 | 56.1 | 1.18 | 0.903 | 0.49 | 4.30 | 1.10 | 6.2 | C | D |
| Example 2 | | | | | | | | | | | | | | |
| Example 13 | 7.99 | 56.1 | 30.0 | 1.11 | 2.8 | 10.0 | 1.20 | 0.770 | 0.16 | 2.61 | 2.56 | 2.3 | A | B |
| Example 14 | 5.8 | 52.4 | 38.5 | 1.5 | 3.0 | 47.7 | 1.13 | 0.916 | 0.16 | 1.50 | 0.85 | 1.5 | B | A |
| Example 15 | 7.99 | 56.1 | 30.0 | 1.11 | 2.8 | 70.0 | 1.08 | 0.884 | 0.15 | 2.00 | 1.20 | 0.1 | A | A |
| Example 16 | 5.6 | 49.0 | 41.0 | 1.6 | 2.8 | 80.0 | 1.08 | 0.910 | 0.08 | 2.20 | 1.21 | 0.5 | A | A |
| Example 17 | 6.5 | 50.0 | 40.0 | 1.3 | 2.2 | 120 | 1.08 | 0.940 | 0.06 | 2.20 | 1.28 | 0.5 | A | A |
| Example 18 | 7.99 | 56.1 | 30.0 | 1.11 | 2.8 | 120 | 1.08 | 0.940 | 0.08 | 2.16 | 1.25 | 2.4 | A | B |
| Example 19 | 7.99 | 56.1 | 30.0 | 1.11 | 2.8 | 200 | 1.10 | 0.930 | 0.08 | 2.21 | 1.30 | 2.8 | A | B |
| Example 20 | 3.1 | 93.0 | 3.8 | 0.1 | 0.2 | 64.3 | 1.20 | 0.088 | 0.029 | 1.65 | 0.87 | 4.6 | B | B |
| Example 21 | 7.2 | 64.4 | 26.4 | 0.7 | 1.3 | 61.0 | 1.22 | 0.880 | 0.056 | 1.60 | 0.87 | 1.3 | A | A |
| Example 22 | 9.2 | 64.4 | 26.4 | 0.31 | 0.4 | 64.3 | 1.10 | 0.881 | 0.10 | 1.67 | 0.87 | 1.1 | B | A |
| Example 23 | 8.5 | 59.1 | 26.4 | 1.8 | 3.2 | 61.0 | 1.22 | 0.880 | 0.16 | 1.67 | 0.85 | 1.7 | A | A |
| Example 24 | 12.7 | 54.0 | 26.4 | 2.6 | 4.3 | 61.0 | 1.20 | 0.880 | 0.22 | 1.67 | 0.90 | 1.5 | B | A |
| Example 25 | 6.0 | 49.7 | 41.0 | 1.5 | 2.4 | 56.1 | 1.18 | 0.903 | 0.32 | 3.80 | 0.94 | 1.4 | A | A |
| Example 26 | 12.4 | 56.6 | 26.4 | 1.1 | 3.9 | 56.1 | 1.18 | 0.903 | 0.35 | 3.70 | 0.94 | 0.9 | A | A |
| Example 27 | 8.3 | 60.0 | 25.0 | 2.5 | 4.2 | 48.0 | 1.10 | 0.920 | 0.41 | 1.50 | 0.85 | 1.5 | B | A |
| Example 28 | 9.6 | 56.2 | 30.0 | 1.5 | 2.7 | 56.1 | 1.18 | 0.903 | 0.44 | 3.80 | 0.94 | 1.4 | A | A |
| Comparative | 6.79 | 57.1 | 30.0 | 1.11 | 5.0 | 64.3 | 1.10 | 0.881 | 0.63 | 3.80 | 0.90 | 5.2 | C | C |
| Example 3 | | | | | | | | | | | | | | |
| Example 29 | 11.2 | 60.5 | 26.4 | 0.7 | 1.2 | 60.0 | 1.10 | 0.840 | 0.22 | 3.70 | 0.93 | 1.2 | A | A |
| Example 30 | 9.8 | 61.0 | 26.4 | 1.0 | 1.8 | 60.0 | 1.20 | 0.910 | 0.33 | 4.00 | 0.95 | 1.5 | A | A |
| Example 31 | 12.0 | 59.8 | 26.4 | 0.7 | 1.1 | 60.0 | 1.10 | 0.840 | 0.22 | 3.90 | 1.00 | 2.3 | A | B |
| Example 32 | 8.8 | 62.1 | 26.4 | 1.0 | 1.7 | 60.0 | 1.20 | 0.910 | 0.33 | 3.80 | 0.98 | 1.5 | A | A |
| Example 33 | 7.8 | 63.2 | 26.4 | 1.0 | 1.6 | 63.0 | 1.10 | 0.900 | 0.35 | 3.80 | 0.93 | 0.9 | A | A |

Manufacturing of Toner and Developer and Image Formation by Actual Machine

Developers containing any one of the silica particles of Examples 1 to 33 are manufactured as follows, and images are formed.

Preparation of Resin Particle Dispersion (1)
Ethylene glycol: 37 parts
Neopentyl glycol: 65 parts
1,9-Nonanediol: 32 parts
Terephthalic acid 96 parts

The above materials are put in a flask, the temperature is raised to 200° C. for 1 hour, and after it is confirmed that the inside of the reaction system is uniformly stirred, 1.2 parts of dibutyltin oxide is added. The temperature is raised to 240° C. for 6 hours in a state where the generated water is being distilled off, and stirring is continued at 240° C. for 4 hours, thereby obtaining a polyester resin (acid value 9.4 mgKOH/g, weight-average molecular weight 13,000, glass transition temperature 62° C.). The molten polyester resin is transferred as it is to an emulsifying disperser (CAVITRON CD1010, Eurotech Ltd.) at a rate of 100 g/min. Separately, dilute aqueous ammonia having a concentration of 0.37% obtained by diluting the reagent aqueous ammonia with deionized water is put in a tank and transferred to an emulsifying disperser together with the polyester resin at a rate of 0.1 L/min while being heated at 120° C. by a heat exchanger. The emulsifying disperser is operated under the conditions of a rotation speed of a rotor of 60 Hz and a pressure of 5 kg/cm², thereby obtaining a resin particle dispersion (1) having a volume-average particle size of 160 nm and a solid content of 30%.

Preparation of Resin Particle Dispersion (2)
Decanedioic acid: 81 parts
Hexanediol: 47 parts

The above materials are put in a flask, the temperature is raised to 160° C. for 1 hour, and after it is confirmed that the inside of the reaction system is uniformly stirred, 0.03 parts of dibutyltin oxide is added. While the generated water is being distilled off, the temperature is raised to 200° C. for 6 hours, and stirring is continued for 4 hours at 200° C. Thereafter, the reaction solution is cooled, solid-liquid separation is performed, and the solid is dried at a temperature of 40° C. under reduced pressure, thereby obtaining a polyester resin (C1) (melting point 64° C., weight-average molecular weight of 15,000).
Polyester resin (C1): 50 parts
Anionic surfactant (NEOGEN SC, manufactured by DKS Co. Ltd.): 2 parts
Deionized water: 200 parts

The above materials are heated to 120° C., thoroughly dispersed with a homogenizer (ULTRA-TURRAX T50, manufactured by IKA), and then subjected to a dispersion treatment with a pressure jet-type homogenizer. At a point in time when the volume-average particle size reaches 180 nm, the dispersed resultant is collected, thereby obtaining a resin particle dispersion (2) having a solid content of 20%.

Preparation of Colorant Particle Dispersion (1)
Cyan pigment (PigmentBlue 15:3, manufactured by Dainichiseika Color & Chemicals Mfg. Co., Ltd.): 50 parts
Anionic surfactant (NEOGEN SC, manufactured by DKS Co. Ltd.): 2 parts
Deionized water: 200 parts

The above materials are mixed together and dispersed for 1 hour with a high-pressure impact disperser ULTIMIZER (HJP30006, manufactured by SUGINO MACHINE LIMITED), thereby obtaining a colorant particle dispersion (1) having a volume-average particle size of 180 nm and a solid content of 20%.

Preparation of Release Agent Particle Dispersion (1)
Paraffin wax (HNP-9, manufactured by NIPPON SEIRO CO., LTD.): 50 parts
Anionic surfactant (NEOGEN SC, manufactured by DKS Co. Ltd.): 2 parts
Deionized water: 200 parts

The above materials are heated to 120° C., thoroughly dispersed with a homogenizer (ULTRA-TURRAX T50, manufactured by IKA), and then subjected to a dispersion treatment with a pressure jet-type homogenizer. At a point in time when the volume-average particle size reaches 200 nm, the dispersed resultant is collected, thereby obtaining a release agent particle dispersion (1) having a solid content of 20%.

Preparation of Toner Particles (1)
Resin particle dispersion (1): 150 parts
Resin particle dispersion (2): 50 parts
Colorant particle dispersion (1): 25 parts
Release agent particle dispersion (1): 35 parts
Polyaluminum chloride: 0.4 parts
Deionized water: 100 parts

The above materials are put in a stainless steel flask, thoroughly mixed and dispersed together by using a homogenizer (ULTRA-TURRAX T50, IKA), and then heated to 48° C. in an oil bath for heating in a state where the inside of the flask is being stirred. The internal temperature of the reaction system is kept at 48° C. for 60 minutes, and then 70 parts of the resin particle dispersion (1) is slowly added thereto. Thereafter, the pH is adjusted to 8.0 by using a 0.5 mol/L aqueous sodium hydroxide solution, the flask is then sealed, heated to 90° C. while being continuously stirred with a stirring shaft with a magnetic seal, and kept at 90° C. for 30 minutes. Next, the mixture is cooled at a cooling rate of 5° C./min, subjected to solid-liquid separation, and thoroughly washed with deionized water. Then, the mixture is subjected to solid-liquid separation, redispersed in deionized water at 30° C., and stirred and washed at a rotation speed of 300 rpm for 15 minutes. This washing operation is repeated 6 more times, and at a point time when the pH of the filtrate reaches 7.54 and the electrical conductivity thereof reaches 6.5 S/cm, solid-liquid separation is performed. The solids are dried in a vacuum for 24 hours, thereby obtaining toner particles (1). The volume-average particle size of the toner particles (1) is 5.7 μm.

Manufacturing of Carrier
Cyclohexyl methacrylate resin (weight-average molecular weight 50,000): 54 parts
Carbon black (manufactured by Cabot Corporation, VXC72): 6 parts
Toluene: 250 parts
Isopropyl alcohol: 50 parts

The above materials and glass beads (diameter 1 mm, the same amount as toluene) are put in a sand mill and stirred at a rotation speed of 190 rpm for 30 minutes, thereby obtaining a coating agent.

Ferrite particles (1,000 parts, volume-average particle size of 35 m) and 150 parts of the coating agent are put in a kneader and mixed together at room temperature (25° C.) for 20 minutes. Then, the mixture is heated to 70° C. and dried under reduced pressure. The dried product is cooled to room temperature (25° C.), taken out of the kneader, and sieved with a mesh having an opening size of 75 μm to remove coarse powder, thereby obtaining a carrier.

Manufacturing of Toner and Developer
Toner particles (1): 100 parts
Any one of the silica particles of Examples 1 to 33: 1.0 part
Dimethyl silicone oil-treated silica particles: 1.0 part

The above materials are mixed together with a Henschel mixer and sieved with a vibration sieve having an opening size of 45 μm, thereby obtaining a toner. The toner (8 parts) and 100 parts of the carrier are put in a V blender, stirred, and sieved with a sieve having an opening size of 212 μm, thereby obtaining a developer.

Image Formation by Actual Machine

An image forming apparatus ApeosPort-VI C7771 (manufactured by FUJIFILM Business Innovation Corp.) is prepared, and a developing device of the apparatus is filled with any of the developers. An image is formed on A4-size normal paper by the developer of each example.

(((1)))

Silica particles comprising:
silica base particles,
a coating structure that coats the silica base particles and consists of a reaction product of a trifunctional silane compound, and
a nitrogen element-containing compound that has adhered to the coating structure and contains a molybdenum element,
wherein in a molybdenum element map created by SEM-EDX, a ratio of a total area of a region forming a lump having a long diameter of 500 nm or more is 5% or less to a total area of the molybdenum element.

(((2)))

The silica particles according to (((1))),
wherein the nitrogen element-containing compound containing a molybdenum element is at least one compound selected from the group consisting of a quaternary ammonium salt containing a molybdenum element and a mixture of a quaternary ammonium salt and a metal oxide containing a molybdenum element.

(((3)))

The silica particles according to (((1))),
wherein the nitrogen element-containing compound containing a molybdenum element is a compound with a CAS Registry Number 117342-25-3.

(((4)))

The silica particles according to any one of (((1))) to (((3))),
wherein the trifunctional silane compound includes an alkyltrialkoxysilane.

(((5)))

The silica particles according to any one of (((1))) to (((4))),
wherein a ratio N_{Mo}/N_{Si} of Net intensity N_{Mo} of the molybdenum element measured by X-ray fluorescence analysis to Net intensity N_{Si} of a silicon element measured by X-ray fluorescence analysis is 0.035 or more and 0.45 or less.

(((6)))

The silica particles according to any one of (((1))) to (((4))),
wherein a ratio N_{Mo}/N_{Si} of Net intensity N_{Mo} of the molybdenum element measured by X-ray fluorescence analysis to Net intensity N_{Si} of a silicon element measured by X-ray fluorescence analysis is 0.05 or more and 0.35 or less.

(((7)))

The silica particles according to any one of (((1))) to (((6))),
wherein in a case where A represents a pore volume of pores having a diameter of 1 nm or more and 50 nm or less determined from a pore size distribution curve obtained by a nitrogen adsorption method before baking at 350° C., and B represents a pore volume of pores having a diameter of 1 nm or more and 50 nm or less determined from a pore size distribution curve obtained by a nitrogen adsorption method after baking at 350° C., B/A is 1.2 or more and 5 or less, and B is 0.2 cm3/g or more and 3 cm3/g or less.

(((8)))

The silica particles according to any one of (((1))) to (((7))),
wherein an average primary particle size of the silica particles is 10 nm or more and 200 nm or less.

(((9)))

The silica particles according to any one of (((1))) to (((8))),
wherein a particle size distribution index of the silica particles is 1.1 or more and 2.0 or less.

(((10)))

The silica particles according to any one of (((1))) to (((9))),
wherein an average circularity of the silica particles is 0.60 or more and 0.96 or less.

(((11)))

An electrostatic charge image developing toner comprising:
toner particles and the silica particles according to any one of (((1))) to (((10))) that are added to an exterior of the toner particles.

(((12)))

An electrostatic charge image developer comprising:
the electrostatic charge image developing toner according to (((11))).

(((13)))

A toner cartridge comprising:
a container that contains the electrostatic charge image developing toner according to (((11))),
wherein the toner cartridge is detachable from an image forming apparatus.

(((14)))

A process cartridge comprising:
a developing unit that contains the electrostatic charge image developer according to (((12))) and develops an electrostatic charge image formed on a surface of an image holder as a toner image by using the electrostatic charge image developer,
wherein the process cartridge is detachable from an image forming apparatus.

(((15)))

An image forming apparatus comprising:
an image holder,
a charging unit that charges a surface of the image holder,
an electrostatic charge image forming unit that forms an electrostatic charge image on the charged surface of the image holder,
a developing unit that contains the electrostatic charge image developer according (((12))) and develops the electrostatic charge image formed on the surface of the image holder as a toner image by using the electrostatic charge image developer,
a transfer unit that transfers the toner image formed on the surface of the image holder to a surface of a recording medium, and
a fixing unit that fixes the toner image transferred to the surface of the recording medium.

(((16)))

An image forming method comprising:
charging a surface of an image holder,
forming an electrostatic charge image on the charged surface of the image holder;
developing the electrostatic charge image formed on the surface of the image holder as a toner image by using the electrostatic charge image developer according to (((12))),
transferring the toner image formed on the surface of the image holder to a surface of a recording medium, and
fixing the toner image transferred to the surface of the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. Silica particles comprising:
silica base particles;
a coating structure that coats the silica base particles and consists of a reaction product of a trifunctional silane compound; and
a nitrogen element-containing compound that has adhered to the coating structure and contains a molybdenum element,
wherein in a molybdenum element map created by SEM-EDX, a ratio of a total area of a region forming a lump having a long diameter of 500 nm or more is 5% or less to a total area of the molybdenum element.

2. The silica particles according to claim 1,
wherein the nitrogen element-containing compound containing a molybdenum element is at least one compound selected from the group consisting of a quaternary ammonium salt containing a molybdenum element and a mixture of a quaternary ammonium salt and a metal oxide containing a molybdenum element.

3. The silica particles according to claim 1,
wherein the nitrogen element-containing compound containing a molybdenum element is a compound with a CAS Registry Number 117342-25-3.

4. The silica particles according to claim 1,
wherein the trifunctional silane compound includes an alkyltrialkoxysilane.

5. The silica particles according to claim 1,
wherein a ratio N_{Mo}/N_{Si} of Net intensity N_{Mo} of the molybdenum element measured by X-ray fluorescence analysis to Net intensity N_{Si} of a silicon element measured by X-ray fluorescence analysis is 0.035 or more and 0.45 or less.

6. The silica particles according to claim 1,
wherein a ratio N_{Mo}/N_{Si} of Net intensity N_{Mo} of the molybdenum element measured by X-ray fluorescence analysis to Net intensity N_{Si} of a silicon element measured by X-ray fluorescence analysis is 0.05 or more and 0.35 or less.

7. The silica particles according to claim 1,
wherein in a case where A represents a pore volume of pores having a diameter of 1 nm or more and 50 nm or less determined from a pore size distribution curve obtained by a nitrogen adsorption method before baking at 350° C., and B represents a pore volume of pores having a diameter of 1 nm or more and 50 nm or less determined from a pore size distribution curve obtained by a nitrogen adsorption method after baking at 350° C., B/A is 1.2 or more and 5 or less, and B is 0.2 cm³/g or more and 3 cm³/g or less.

8. The silica particles according to claim 1,
wherein an average primary particle size of the silica particles is 10 nm or more and 200 nm or less.

9. The silica particles according to claim 1,
wherein a particle size distribution index of the silica particles is 1.1 or more and 2.0 or less.

10. The silica particles according to claim 1,
wherein an average circularity of the silica particles is 0.60 or more and 0.96 or less.

11. An electrostatic charge image developing toner comprising:
toner particles; and
the silica particles according to claim 1 that are added to an exterior of the toner particles.

12. An electrostatic charge image developing toner comprising:
toner particles; and
the silica particles according to claim 2 that are added to an exterior of the toner particles.

13. An electrostatic charge image developing toner comprising:
toner particles; and
the silica particles according to claim 3 that are added to an exterior of the toner particles.

14. An electrostatic charge image developing toner comprising:
toner particles; and
the silica particles according to claim 4 that are added to an exterior of the toner particles.

15. An electrostatic charge image developing toner comprising:
toner particles; and
the silica particles according to claim 5 that are added to an exterior of the toner particles.

16. An electrostatic charge image developer comprising:
the electrostatic charge image developing toner according to claim 11.

17. A toner cartridge comprising:
a container that contains the electrostatic charge image developing toner according to claim 11,
wherein the toner cartridge is detachable from an image forming apparatus.

18. A process cartridge comprising:
a developing unit that contains the electrostatic charge image developer according to claim 16 and develops an electrostatic charge image formed on a surface of an image holder as a toner image by using the electrostatic charge image developer,
wherein the process cartridge is detachable from an image forming apparatus.

19. An image forming apparatus comprising:
an image holder;
a charging unit that charges a surface of the image holder;
an electrostatic charge image forming unit that forms an electrostatic charge image on the charged surface of the image holder;
a developing unit that contains the electrostatic charge image developer according to claim 16 and develops the electrostatic charge image formed on the surface of the image holder as a toner image by using the electrostatic charge image developer;
a transfer unit that transfers the toner image formed on the surface of the image holder to a surface of a recording medium; and
a fixing unit that fixes the toner image transferred to the surface of the recording medium.

20. An image forming method comprising:
charging a surface of an image holder;
forming an electrostatic charge image on the charged surface of the image holder;
developing the electrostatic charge image formed on the surface of the image holder as a toner image by using the electrostatic charge image developer according to claim 16;
transferring the toner image formed on the surface of the image holder to a surface of a recording medium; and
fixing the toner image transferred to the surface of the recording medium.
